(19) United States
(12) Patent Application Publication
(10) Pub. No.: US 2013/0163664 A1
(43) Pub. Date: Jun. 27, 2013

(54) UNIFIED PARTITION MODE TABLE FOR INTRA-MODE CODING

(71) Applicant: QUALCOMM INCORPORATED, San Diego, CA (US)

(72) Inventors: Liwei Guo, San Diego, CA (US); Xianglin Wang, San Diego, CA (US); Marta Karczewicz, San Diego, CA (US)

(73) Assignee: QUALCOMM INCORPORATED, San Diego, CA (US)

(21) Appl. No.: 13/722,474

(22) Filed: Dec. 20, 2012

Related U.S. Application Data
(60) Provisional application No. 61/579,044, filed on Dec. 22, 2011.
(60) Provisional application No. 61/592,389, filed on Jan. 30, 2012.

(51) Int. Cl. H04N 7/26

(52) U.S. Cl. CPC H04N 19/00793
USPC 375/240.12

(57) ABSTRACT

In an example, aspects of this disclosure relate to a method for coding video data that includes predicting a first non-square partition of a current block of video data using a first intra-prediction mode, where the first non-square partition has a first size. The method also includes predicting a second non-square partition of the current block of video data using a second intra-prediction mode, where the second non-square partition has a second size different than the first size. The method also includes coding the current block based on the predicted first and second non-square partitions.

This application claims priority to U.S. Provisional Application No. 61/579,044, filed 22 Dec. 2011, and U.S. Provisional Application No. 61/592,389, filed 30 Jan. 2012, the contents of both of which are hereby incorporated by reference in their entirety.

### TECHNICAL FIELD

This disclosure relates to video coding, and more particularly to techniques for performing intra-prediction when coding video data.

### BACKGROUND

Digital video capabilities can be incorporated into a wide range of devices, including digital televisions, digital direct broadcast systems, wireless broadcast systems, personal digital assistants (PDAs), laptop or desktop computers, digital cameras, digital recording devices, digital media players, video gaming devices, video game consoles, cellular or satellite radio telephones, video teleconferencing devices, and the like. Digital video devices implement video compression techniques, such as those described in the standards defined by MPEG-2, MPEG-4, ITU-T H.263, ITU-T H.264/MPEG-4, Part 10, Advanced Video Coding (AVC), the High Efficiency Video Coding (HEVC) standard presently under development, and extensions of such standards, to transmit, receive and store digital video information more efficiently.

Video compression techniques include spatial prediction and/or temporal prediction to reduce or remove redundancy inherent in video sequences. For block-based video coding, a video frame or slice may be partitioned into blocks. Each block can be further partitioned. Blocks in an intra-coded (I) frame or slice are encoded using spatial prediction with respect to reference samples in neighboring blocks in the same frame or slice. Blocks in an inter-coded (P or B) frame or slice may use spatial prediction with respect to reference samples in neighboring blocks in the same frame or slice or temporal prediction with respect to reference samples in other reference frames. Spatial or temporal prediction results in a predictive block for a block to be coded. Residual data represents pixel differences between the original block to be coded and the predictive block.

An inter-coded block is encoded according to a motion vector that points to a block of reference samples forming the predictive block, and the residual data indicating the difference between the coded block and the predictive block. An intra-coded block is encoded according to an intra-coding mode and the residual data. For further compression, the residual data may be transformed from the pixel domain to a transform domain, resulting in residual transform coefficients, which then may be quantized. The quantized transform coefficients, initially arranged in a two-dimensional array, may be scanned in a particular order to produce a one-dimensional vector of transform coefficients for entropy coding.

### SUMMARY

In general, this disclosure describes techniques for intra-coding data using short distance intra-prediction (SDIP). Aspects of this disclosure relate to reducing or eliminating the need for additional syntax elements when implementing SDIP. For example, according aspects of this disclosure, SDIP modes may be incorporated into a partition mode table. Accordingly, a video coder may implement SDIP without using separate SDIP flags (e.g., such as SDIP_Flag and/or SDIP_direction_Flag). Aspects of this disclosure also relate to techniques for predicting a block of video data using asymmetric short distance intra prediction (SDIP) partitions.

In an example, aspects of this disclosure relate to a method of coding video data that includes predicting a first non-square partition of a current block of video data using a first intra-prediction mode, wherein the first non-square partition has a first size, predicting a second non-square partition of the current block of video data using a second intra-prediction mode, wherein the second non-square partition has a second size different than the first size, and coding the current block based on the predicted first and second non-square partitions.

In another example, aspects of this disclosure relate to an apparatus for coding video data that includes one or more processors configured to predict a first non-square partition of a current block of video data using a first intra-prediction mode, wherein the first non-square partition has a first size, predict a second non-square partition of the current block of video data using a second intra-prediction mode, wherein the second non-square partition has a second size different than the first size, and code the current block based on the predicted first and second non-square partitions.

In another example, aspects of this disclosure relate to an apparatus for coding video data that includes means for predicting a first non-square partition of a current block of video data using a first intra-prediction mode, wherein the first non-square partition has a first size, means for predicting a second non-square partition of the current block of video data using a second intra-prediction mode, wherein the second non-square partition has a second size different than the first size, and means for coding the current block based on the predicted first and second non-square partitions.

In another example, aspects of this disclosure relate to a non-transitory computer-readable storage medium having instructions stored thereon that, when executed, cause one or more processors to predict a first non-square partition of a current block of video data using a first intra-prediction mode, wherein the first non-square partition has a first size, predict a second non-square partition of the current block of video data using a second intra-prediction mode, wherein the second non-square partition has a second size different than the first size, and code the current block based on the predicted first and second non-square partitions.

The details of one or more aspects of the disclosure are set forth in the accompanying drawings and the description below. Other features, objects, and advantages of the techniques described in this disclosure will be apparent from the description and drawings, and from the claims.

### BRIEF DESCRIPTION OF DRAWINGS

FIG. 1 is a block diagram illustrating an example video encoding and decoding system that may implement the techniques of this disclosure.

FIG. 2 is a block diagram illustrating an example video encoder that may implement the techniques of this disclosure.

FIG. 3 is a block diagram illustrating an example video decoder that may implement the techniques of this disclosure.

FIGS. 4A and 4B are conceptual diagrams illustrating an example quadtree and a corresponding largest coding unit (LCU).

FIG. 5 is a conceptual diagram illustrating example intra-prediction mode directions.

FIG. 6 is a conceptual diagram illustrating example partition modes for predicting video data.

FIG. 7 is a conceptual diagram illustrating an example largest coding unit (LCU) including a short distance intra-prediction (SDIP) predicted CU.

FIG. 8 is a conceptual diagram illustrating various examples of blocks partitioned using asymmetric partition modes of SDIP.

FIG. 9 is a conceptual diagram illustrating an example partitioning structure for non-square quadtree partitioning.

FIG. 10 is a flow diagram illustrating an example process for encoding video data using a partition mode table, according to aspects of this disclosure.

FIG. 11 is a flow diagram illustrating an example process for decoding video data using a partition mode table, according to aspects of this disclosure.

FIG. 12 is a flowchart illustrating an example method for encoding a current block.

FIG. 13 is a flowchart illustrating an example method for decoding a current block of video data.

### DETAILED DESCRIPTION

Video coding devices implement video compression techniques to encode and decode video data efficiently. Video compression techniques may include applying spatial (intra-frame) prediction and/or temporal (inter-frame) prediction techniques to reduce or remove redundancy inherent in video sequences. A video encoder typically partitions each picture of an original video sequence into rectangular regions referred to as video blocks or coding units (described in greater detail below). These video blocks may be encoded using an intra mode (I-mode) or using an inter mode (P-mode or B-mode).

For P-mode and B-mode, a video encoder first searches for a block similar to the one being encoded in a frame in another temporal location, referred to as a reference frame and denoted as F_{ref}. The video encoder may restrict the search to a certain spatial displacement from the block to be encoded. A best match may be located using a two-dimensional (2D) motion vector (Δx, Δy) where Δx is the horizontal and Δy is the vertical displacement. Accordingly, the video encoder can construct the predicted block F_{pred} using the motion vector and the reference picture to which the best match belongs according to the following equation:

F_{pred}(x,y)=F_{ref}(x+Δx,y+Δy)

where the location of a pixel within the picture is denoted by (x, y).

For blocks encoded in I-mode, the video encoder may form the predicted block using spatial prediction techniques based on data from previously encoded neighboring blocks within the same picture.

In any case, for both I-mode and P- or B-mode, the prediction error, i.e., the difference between the pixel values in the block being encoded and the predicted block, may be represented as a set of weighted basis functions of a discrete transform, such as a discrete cosine transform (DCT). Transforms may be performed using different sizes of blocks, such as 4×4, 8×8 or 16×16 and larger. The shape of a transform block need not always be square. For example, rectangular shaped transform blocks may also be used, e.g. with a transform block size of 16×4, 32×8, etc.

After transformation, the weights (i.e., the transform coefficients) are subsequently quantized. Quantization introduces a loss of information, and as such, quantized coefficients have lower precision than the original transform coefficients. The compression ratio, i.e. the ratio of the number of bits used to represent original sequence and the compressed one, may be controlled by adjusting the value of the quantization parameter (QP) used when quantizing transform coefficients.

The quantized transform coefficients and motion vectors are examples of syntax elements, and, along with control information, form a coded representation of a video sequence. In some instances, the video encoder may entropy code syntax elements, thereby further reducing the number of bits needed for their representation. Entropy coding is a lossless operation aimed at minimizing the number of bits required to represent transmitted or stored symbols (e.g., syntax elements) by utilizing properties of the distribution of the syntax elements (e.g., recognizing that some symbols occur more frequently than others).

A video decoder may, using the syntax elements and control information discussed above, construct predictive data (e.g., a predictive block) for decoding a current frame. For example, the video decoder may add the predicted block and the compressed prediction error. The video decoder may determine the compressed prediction error by weighting the transform basis functions using the quantized coefficients. The difference between the reconstructed frame and the original frame is called reconstruction error.

The Joint Cooperative Team for Video Coding (JCT-VC) is currently developing a new coding standard referred to as high efficiency video coding (HEVC). In HEVC picture may be partitioned into coding units. A coding unit (CU) generally refers to an image region that serves as a basic unit to which various coding tools are applied for video compression. A CU usually has a luminance component, denoted as Y, and two chroma components, denoted as U and V.

CUs generally include one or more prediction units (PUs) that describe how data for the CU is predicted. A CU may include information indicating prediction modes for PUs of the CU. For example, information for a CU may indicate prediction modes for one or more portions of the CU. In some examples, a CU may be divided, or partitioned, in to more than one portion for purposes of prediction.

As described in this disclosure, a prediction partition mode (or prediction partitioning mode) may generally refer to the manner in which a block (such as a CU, e.g., a leaf-node CU) is divided for purposes of prediction. For example, assuming that the size of a particular CU is 2N×2N, the CU may be predicted as a whole using a 2N×2N PU (referred to as an 2N×2N partition mode). In another example, the CU may be predicted using four equally sized PUs that are N×N in size (referred to as an N×N partition mode).

In some examples, short-distance intra-prediction (SDIP) mode may be used for coding intra-predicted blocks. SDIP generally allows a CU to be divided into parallel, non-square PUs. For example, SDIP may be used to divide a CU into multiple parallel PUs that are 2N×hN or hN×2N in size, where “h” represents one-half. In other words, “hN” is equivalent to N/2. In an example for purposes of illustration, an 8×8 CU may be divided into four 8×2 PUs, where “N×M” refers to N pixels vertically and M pixels horizontally, in this example. In this example, the first PU may be predicted from neighboring pixels to the CU, the second PU may be predicted from neighboring pixels including pixels of the first PU, the third PU may be predicted from neighboring pixels including pixels of the second PU, and the fourth PU may be predicted from neighboring pixels including pixels of the third PU. In this manner, rather than predicting all pixels of the CU from pixels of neighboring, previously coded blocks to the CU, pixels within the CU may be used to predict other pixels within the same CU, using SDIP.

Information regarding partitioning modes may be provided in a variety of ways. For example, partition information, e.g., whether a CU is predicted using PUs sized 2N×2N and N×N for intra-coded blocks, or 2N×2N, 2N×N, N×2N, N×N for inter-coded blocks, may be provided using a partition mode table. The partition mode table may map each of the modes to syntax elements. In some examples, the syntax elements may be bin strings (a binary sting of bits) that may be coded by an entropy coder. In any case, the table may be maintained at both an encoder and a decoder. Accordingly, the partition information for a particular CU can be identified according to an entry in the partition mode table.

In other examples, partition information may be signaled using one or more other syntax elements (not associated with a mode table). For example, a video encoder may provide an indication in an encoded bitstream that SDIP is used to predict a particular CU. Accordingly, a video decoder may determine that the particular CU has been intra-predicted using SDIP upon decoding such signaling. In some examples, the syntax for SDIP modes may include the following elements:
1. SDIP_Flag: a flag for signaling that a CU is encoded as square prediction (2N×2N, N×N) or SDIP type (2N×hN and hN×2N). For example, if SDIP_Flag is equal to zero, the CU is encoded as square prediction unit. However, if SDIP_Flag is equal to one, the CU is encoded using SDIP partitioning.
2. SDIP_direction_Flag: a flag for signaling which SDIP mode is used. For example, if SDIP_direction_Flag is equal to zero, the hN×2N mode may be used. However, if SDIP_direction_Flag is equal to one, the 2N×hN mode may be used.

In the example above, both the SDIP_Flag and SDIP_direction_Flag can be coded using CABAC (context-adaptive binary arithmetic coding).

In the example above, the SDIP_Flag and the SDIP_direction_Flag syntax elements must be provided in addition to syntax elements defined by a partition mode table (described above). Moreover, as noted above, the SDIP_Flag and SDIP_direction_Flag may require additional CABAC contexts to be defined and maintained. Accordingly, the signaling of SDIP flags may be relatively computationally intensive and/or costly bit-wise.

Aspects of this disclosure relate to reducing or eliminating the need for additional syntax elements when implementing SDIP. For example, according to some aspects of this disclosure, the SDIP_Flag and the SDIP_direction_Flag syntax elements may be eliminated. In this example, rather than using flags to signal SDIP partition information, the SDIP partition information may be incorporated in a partition mode table. Incorporating the SDIP partition information into a partition mode table may simplify codec design. For example, separate SDIP flags will no longer be needed, which may also eliminate the need to generate separate context (for CABAC coding) when coding the flags.

Aspects of this disclosure also relate to predicting a block of video data using asymmetric SDIP partitions. In some examples, according to aspects of this disclosure, syntax data included for a block may include data indicating one or more of: whether the block is predicted in an intra-prediction mode or an inter-prediction mode, when intra-predicted, whether the block is partitioned using SDIP, and if so, whether the block is partitioned using symmetric or asymmetric SDIP. Syntax data for the block may be provided indicating whether the block is asymmetrically partitioned into PUs regardless of whether the block is predicted in an intra- or inter-prediction mode. Thus, the same syntax elements may be used to indicate whether a block is partitioned into asymmetric motion partitions (AMP) or asymmetric SDIP partitions, in some examples.

In other examples, the asymmetric SDIP modes may be included in a unified partition mode table, as described above. For example, in addition to the symmetric SDIP modes, a partition mode table may further include one or more asymmetric SDIP modes.

In any case, this disclosure also provides techniques for representing residual data for asymmetric SDIP partitions. In general, residual data is represented in the transform domain as TUs. In some examples, the TUs may have the same sizes as corresponding asymmetric SDIP partitions, and thus, different sizes from each other. In other examples, the TUs may each have equal sizes to each other, and thus, potentially be different from the sizes of the asymmetric SDIP partitions (although one of the TUs may be the same size as a corresponding asymmetric SDIP partition). In some examples, the TUs may be represented using a residual quadtree (RQT), which may indicate that one or more of the TUs are smaller than the smallest asymmetric SDIP partition of the current block.

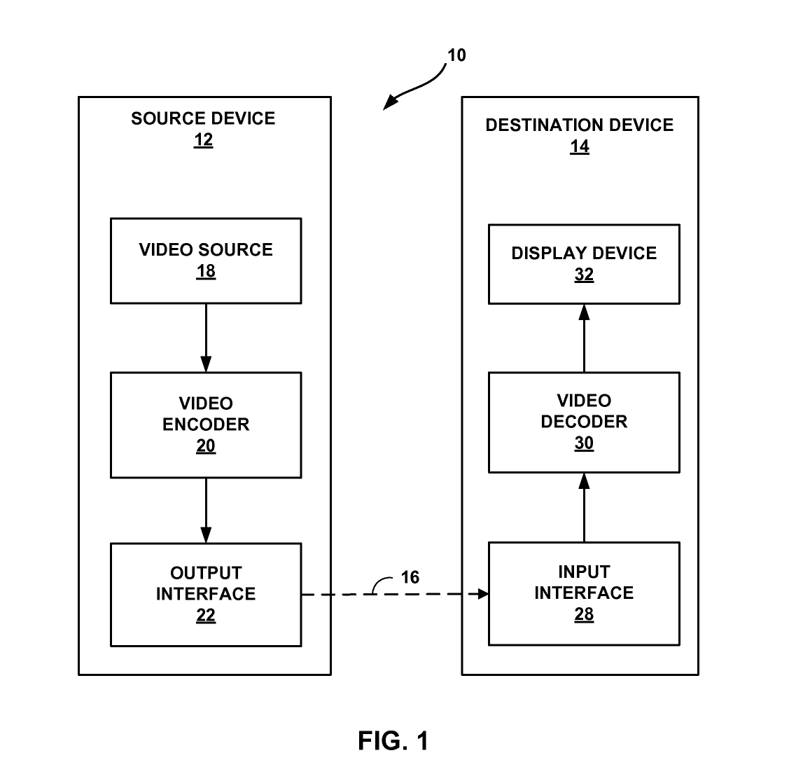

FIG. 1 is a block diagram illustrating an example video encoding and decoding system 10 that may utilize techniques for performing simplified deblocking decisions. As shown in FIG. 1, system 10 includes a source device 12 that provides encoded video data to be decoded at a later time by a destination device 14. In particular, source device 12 provides the video data to destination device 14 via a computer-readable medium 16. Source device 12 and destination device 14 may comprise any of a wide range of devices, including desktop computers, notebook (i.e., laptop) computers, tablet computers, set-top boxes, telephone handsets such as so-called “smart” phones, so-called “smart” pads, televisions, cameras, display devices, digital media players, video gaming consoles, video streaming device, or the like. In some cases, source device 12 and destination device 14 may be equipped for wireless communication.

Destination device 14 may receive the encoded video data to be decoded via computer-readable medium 16. Computer-readable medium 16 may comprise any type of medium or device capable of moving the encoded video data from source device 12 to destination device 14. In one example, computer-readable medium 16 may comprise a communication medium to enable source device 12 to transmit encoded video data directly to destination device 14 in real-time. The encoded video data may be modulated according to a communication standard, such as a wireless communication protocol, and transmitted to destination device 14. The communication medium may comprise any wireless or wired communication medium, such as a radio frequency (RF) spectrum or one or more physical transmission lines. The communication medium may form part of a packet-based network, such as a local area network, a wide-area network, or a global network such as the Internet. The communication medium may include routers, switches, base stations, or any other equipment that may be useful to facilitate communication from source device 12 to destination device 14.

In some examples, encoded data may be output from output interface 22 to a storage device. Similarly, encoded data may be accessed from the storage device by input interface. The storage device may include any of a variety of distributed or locally accessed data storage media such as a hard drive, Blu-ray discs, DVDs, CD-ROMs, flash memory, volatile or non-volatile memory, or any other suitable digital storage media for storing encoded video data. In a further example, the storage device may correspond to a file server or another intermediate storage device that may store the encoded video generated by source device 12. Destination device 14 may access stored video data from the storage device via streaming or download. The file server may be any type of server capable of storing encoded video data and transmitting that encoded video data to the destination device 14. Example file servers include a web server (e.g., for a website), an FTP server, network attached storage (NAS) devices, or a local disk drive. Destination device 14 may access the encoded video data through any standard data connection, including an Internet connection. This may include a wireless channel (e.g., a Wi-Fi connection), a wired connection (e.g., DSL, cable modem, etc.), or a combination of both that is suitable for accessing encoded video data stored on a file server. The transmission of encoded video data from the storage device may be a streaming transmission, a download transmission, or a combination thereof.

The techniques of this disclosure are not necessarily limited to wireless applications or settings. The techniques may be applied to video coding in support of any of a variety of multimedia applications, such as over-the-air television broadcasts, cable television transmissions, satellite television transmissions, Internet streaming video transmissions, such as dynamic adaptive streaming over HTTP (DASH), digital video that is encoded onto a data storage medium, decoding of digital video stored on a data storage medium, or other applications. In some examples, system 10 may be configured to support one-way or two-way video transmission to support applications such as video streaming, video playback, video broadcasting, and/or video telephony.

In the example of FIG. 1, source device 12 includes video source 18, video encoder 20, and output interface 22. Destination device 14 includes input interface 28, video decoder 30, and display device 32. In accordance with this disclosure, video encoder 20 of source device 12 may be configured to apply the techniques for performing simplified deblocking decisions. In other examples, a source device and a destination device may include other components or arrangements. For example, source device 12 may receive video data from an external video source 18, such as an external camera. Likewise, destination device 14 may interface with an external display device, rather than including an integrated display device.

The illustrated system 10 of FIG. 1 is merely one example. Techniques for performing simplified deblocking decisions may be performed by any digital video encoding and/or decoding device. Although generally the techniques of this disclosure are performed by a video encoding device, the techniques may also be performed by a video encoder/decoder, typically referred to as a “CODEC.” Moreover, the techniques of this disclosure may also be performed by a video preprocessor. Source device 12 and destination device 14 are merely examples of such coding devices in which source device 12 generates coded video data for transmission to destination device 14. In some examples, devices 12, 14 may operate in a substantially symmetrical manner such that each of devices 12, 14 include video encoding and decoding components. Hence, system 10 may support one-way or two-way video transmission between video devices 12, 14, e.g., for video streaming, video playback, video broadcasting, or video telephony.

Video source 18 of source device 12 may include a video capture device, such as a video camera, a video archive containing previously captured video, and/or a video feed interface to receive video from a video content provider. As a further alternative, video source 18 may generate computer graphics-based data as the source video, or a combination of live video, archived video, and computer-generated video. In some cases, if video source 18 is a video camera, source device 12 and destination device 14 may form so-called camera phones or video phones. As mentioned above, however, the techniques described in this disclosure may be applicable to video coding in general, and may be applied to wireless and/or wired applications. In each case, the captured, pre-captured, or computer-generated video may be encoded by video encoder 20. The encoded video information may then be output by output interface 22 onto a computer-readable medium 16.

Computer-readable medium 16 may include transient media, such as a wireless broadcast or wired network transmission, or storage media (that is, non-transitory storage media), such as a hard disk, flash drive, compact disc, digital video disc, Blu-ray disc, or other computer-readable media. In some examples, a network server (not shown) may receive encoded video data from source device 12 and provide the encoded video data to destination device 14, e.g., via network transmission. Similarly, a computing device of a medium production facility, such as a disc stamping facility, may receive encoded video data from source device 12 and produce a disc containing the encoded video data. Therefore, computer-readable medium 16 may be understood to include one or more computer-readable media of various forms, in various examples.

This disclosure may generally refer to video encoder 20 “signaling” certain information to another device, such as video decoder 30. It should be understood, however, that video encoder 20 may signal information by associating certain syntax elements with various encoded portions of video data. That is, video encoder 20 may “signal” data by storing certain syntax elements to headers of various encoded portions of video data. In some cases, such syntax elements may be encoded and stored (e.g., stored to computer-readable medium 16) prior to being received and decoded by video decoder 30. Thus, the term “signaling” may generally refer to the communication of syntax or other data for decoding compressed video data, whether such communication occurs in real- or near-real-time or over a span of time, such as might occur when storing syntax elements to a medium at the time of encoding, which then may be retrieved by a decoding device at any time after being stored to this medium.

Input interface 28 of destination device 14 receives information from computer-readable medium 16. The information of computer-readable medium 16 may include syntax information defined by video encoder 20, which is also used by video decoder 30, that includes syntax elements that describe characteristics and/or processing of blocks and other coded units, e.g., GOPs. Display device 32 displays the decoded video data to a user, and may comprise any of a variety of display devices such as a cathode ray tube (CRT), a liquid crystal display (LCD), a plasma display, an organic light emitting diode (OLED) display, or another type of display device.

Video encoder 20 and video decoder 30 each may be implemented as any of a variety of suitable encoder or decoder circuitry, as applicable, such as one or more microprocessors, digital signal processors (DSPs), application specific integrated circuits (ASICs), field programmable gate arrays (FPGAs), discrete logic circuitry, software, hardware, firmware or any combinations thereof. When the techniques are implemented partially in software, a device may store instructions for the software in a suitable, non-transitory computer-readable medium and execute the instructions in hardware using one or more processors to perform the techniques of this disclosure. Each of video encoder 20 and video decoder 30 may be included in one or more encoders or decoders, either of which may be integrated as part of a combined video encoder/decoder (CODEC). A device including video encoder 20 and/or video decoder 30 may comprise an integrated circuit, a microprocessor, and/or a wireless communication device, such as a cellular telephone.

Although not shown in FIG. 1, in some aspects, video encoder 20 and video decoder 30 may each be integrated with an audio encoder and decoder, and may include appropriate MUX-DEMUX units, or other hardware and software, to handle encoding of both audio and video in a common data stream or separate data streams. If applicable, MUX-DEMUX units may conform to the ITU H.223 multiplexer protocol, or other protocols such as the user datagram protocol (UDP).

Video encoder 20 and video decoder 30 may operate according to a video compression standard, such as the ITU-T H.264 standard, alternatively referred to as MPEG-4, Part 10, Advanced Video Coding (AVC), or extensions of such standards. The ITU-T H.264/MPEG-4 (AVC) standard was formulated by the ITU-T Video Coding Experts Group (VCEG) together with the ISO/IEC Moving Picture Experts Group (MPEG) as the product of a collective partnership known as the Joint Video Team (JVT). In some aspects, the techniques described in this disclosure may be applied to devices that generally conform to the H.264 standard. The H.264 standard is described in ITU-T Recommendation H.264, Advanced Video Coding for generic audiovisual services, by the ITU-T Study Group, and dated March, 2005, which may be referred to herein as the H.264 standard or H.264 specification, or the H.264/AVC standard or specification. Other examples of video compression standards include MPEG-2 and ITU-T H.263.

The JCT-VC is working on development of the HEVC standard. While the techniques of this disclosure are not limited to any particular coding standard, the techniques may be relevant to the HEVC standard. The HEVC standardization efforts are based on an evolving model of a video coding device referred to as the HEVC Test Model (HM). The HM presumes several additional capabilities of video coding devices relative to existing devices according to, e.g., ITU-T H.264/AVC. For example, whereas H.264 provides nine intra-prediction encoding modes, the HM may provide as many as thirty-five intra-prediction encoding modes.

In general, the working model of the HM describes that a video frame or picture may be divided into a sequence of treeblocks or largest coding units (LCU) that include both luma and chroma samples. Syntax data within a bitstream may define a size for the LCU, which is a largest coding unit in terms of the number of pixels. A slice includes a number of consecutive treeblocks in coding order. A video frame or picture may be partitioned into one or more slices. Each treeblock may be split into coding units (CUs) according to a quadtree. In general, a quadtree data structure includes one node per CU, with a root node corresponding to the treeblock. If a CU is split into four sub-CUs, the node corresponding to the CU includes four leaf nodes, each of which corresponds to one of the sub-CUs.

Each node of the quadtree data structure may provide syntax data for the corresponding CU. For example, a node in the quadtree may include a split flag, indicating whether the CU corresponding to the node is split into sub-CUs. Syntax elements for a CU may be defined recursively, and may depend on whether the CU is split into sub-CUs. If a CU is not split further, it is referred as a leaf-CU. In this disclosure, four sub-CUs of a leaf-CU will also be referred to as leaf-CUs even if there is no explicit splitting of the original leaf-CU. For example, if a CU at 16×16 size is not split further, the four 8×8 sub-CUs will also be referred to as leaf-CUs although the 16×16 CU was never split.

A CU has a similar purpose as a macroblock of the H.264 standard, except that a CU does not have a size distinction. For example, a treeblock may be split into four child nodes (also referred to as sub-CUs), and each child node may in turn be a parent node and be split into another four child nodes. A final, unsplit child node, referred to as a leaf node of the quadtree, comprises a coding node, also referred to as a leaf-CU. Syntax data associated with a coded bitstream may define a maximum number of times a treeblock may be split, referred to as a maximum CU depth, and may also define a minimum size of the coding nodes. Accordingly, a bitstream may also define a smallest coding unit (SCU). This disclosure uses the term “block” to refer to any of a CU, PU, or TU, in the context of HEVC, or similar data structures in the context of other standards (e.g., macroblocks and sub-blocks thereof in H.264/AVC).

A CU includes a coding node and prediction units (PUs) and transform units (TUs) associated with the coding node. A size of the CU corresponds to a size of the coding node and must be square in shape. The size of the CU may range from 8×8 pixels up to the size of the treeblock with a maximum of 64×64 pixels or greater. Each CU may contain one or more PUs and one or more TUs.

Syntax data associated with a CU may describe, for example, partitioning of the CU into one or more PUs. Partitioning modes may differ between whether the CU is skip or direct mode encoded, intra-prediction mode encoded, or inter-prediction mode encoded. PUs may be partitioned to be non-square in shape. Syntax data associated with a CU may also describe, for example, partitioning of the CU into one or more TUs according to a quadtree. A TU can be square or non-square (e.g., rectangular) in shape.

The HEVC standard allows for transformations according to TUs, which may be different for different CUs. The TUs are typically sized based on the size of PUs within a given CU defined for a partitioned LCU, although this may not always be the case. The TUs are typically the same size or smaller than the PUs. In some examples, residual samples corresponding to a CU may be subdivided into smaller units using a quadtree structure known as “residual quad tree” (RQT). The leaf nodes of the RQT may be referred to as transform units (TUs). Pixel difference values associated with the TUs may be transformed to produce transform coefficients, which may be quantized.

A leaf-CU may include one or more prediction units (PUs). In general, a PU represents a spatial area corresponding to all or a portion of the corresponding CU, and may include data for retrieving a reference sample for the PU. Moreover, a PU includes data related to prediction. For example, when the PU is intra-mode encoded, data for the PU may be included in a residual quadtree (RQT), which may include data describing an intra-prediction mode for a TU corresponding to the PU. As another example, when the PU is inter-mode encoded, the PU may include data defining one or more motion vectors for the PU. The data defining the motion vector for a PU may describe, for example, a horizontal component of the motion vector, a vertical component of the motion vector, a resolution for the motion vector (e.g., one-quarter pixel precision or one-eighth pixel precision), a reference picture to which the motion vector points, and/or a reference picture list (e.g., List 0, List 1, or List C) for the motion vector.

A leaf-CU having one or more PUs may also include one or more transform units (TUs). The transform units may be specified using an RQT (also referred to as a TU quadtree structure), as discussed above. For example, a split flag may indicate whether a leaf-CU is split into four transform units. Then, each transform unit may be split further into further sub-TUs. When a TU is not split further, it may be referred to as a leaf-TU. Generally, for intra coding, all the leaf-TUs belonging to a leaf-CU share the same intra prediction mode. That is, the same intra-prediction mode is generally applied to calculate predicted values for all TUs of a leaf-CU. For intra coding, a video encoder may calculate a residual value for each leaf-TU using the intra prediction mode, as a difference between the portion of the CU corresponding to the TU and the original block. A TU is not necessarily limited to the size of a PU. Thus, TUs may be larger or smaller than a PU. For intra coding, a PU may be collocated with a corresponding leaf-TU for the same CU. In some examples, the maximum size of a leaf-TU may correspond to the size of the corresponding leaf-CU.

Moreover, TUs of leaf-CUs may also be associated with respective quadtree data structures, referred to as residual quadtrees (RQTs). That is, a leaf-CU may include a quadtree indicating how the leaf-CU is partitioned into TUs. The root node of a TU quadtree generally corresponds to a leaf-CU, while the root node of a CU quadtree generally corresponds to a treeblock (or LCU). TUs of the RQT that are not split are referred to as leaf-TUs. In general, this disclosure uses the terms CU and TU to refer to leaf-CU and leaf-TU, respectively, unless noted otherwise.

The HM supports prediction in various PU sizes, also referred to as partition modes. Assuming that the size of a particular CU is 2N×2N, the HM supports intra-prediction in PU sizes of 2N×2N or N×N, and inter-prediction in symmetric PU sizes of 2N×2N, 2N×N, N×2N, or N×N.

The HM also supports asymmetric partitioning for inter-prediction in PU sizes of 2N×nU, 2N×nD, nL×2N, and nR×2N. In asymmetric partitioning, one direction of a CU is not partitioned, while the other direction is partitioned into 25% and 75%. The portion of the CU corresponding to the 25% partition is indicated by an “n” followed by an indication of “Up”, “Down,” “Left,” or “Right.” Thus, for example, “2N×nU” refers to a 2N×2N CU that is partitioned horizontally with a 2N×0.5N PU on top and a 2N×1.5N PU on bottom.

In some examples, video encoder 20 and video decoder 30 may implement SDIP modes to predict a CU using parallel PUs. In such examples, a CU may be predicted with four SDIP PUs in an hN×2N arrangement, where “h” represents one-half. In other examples, a CU may be predicted with four SDIP PUs in an 2N×hN arrangement. Other partitioning arrangements are also possible, such as those associated with a variety of asymmetric SDIP modes, as described below.

Video encoder 20 may provide an indication of a prediction partition mode in a variety of ways. For example, video encoder 20 and video decoder 30 may maintain a partition mode table having a number of different partition modes, e.g., 2N×2N, N×N, and the like for intra-coded blocks, or 2N×2N, 2N×N, N×2N, N×N, and the like for inter-coded blocks. Video encoder 20 may indicate a particular partition mode by including a syntax element (e.g., bin string) in an encoded bitstream that maps to a partition mode in the partition mode table. Accordingly, video decoder 30 may parse the syntax element from the encoded bitstream and identify the same partition mode in the partition mode table.

In other examples, video encoder 20 may indicate a partition mode without using a partition mode table. For example, video encoder 20 may include one or more syntax elements that directly indicate a particular partition mode (e.g., SDIP_Flag and SDIP_direction_Flag). Video encoder 20 may use such syntax elements, in some instances, to indicate an SDIP mode. Video encoder 20 may CABAC code the syntax elements. In this example, video decoder 30 may parse the syntax elements from the encoded bitstream and identify the partition mode.

Using a combination of partition mode tables and independent syntax elements may help to reduce the size of partition mode tables, thereby potentially reducing the number of bits associated with signaling a partition mode from the partition mode table. For example, infrequently used partition modes may be removed from a partition mode table and may be independently signaled. In this way, the most frequently used partition modes may be associated with relatively shorter binarized syntax elements.

However, providing separate syntax elements for one or more partition modes may increase the overall number of bits required. For example, video encoder 20 must send the separate syntax elements (e.g., such as SDIP_Flag and SDIP_direction_Flag) in addition to the syntax elements associated with a partition mode table. In addition, the video encoder 20 may be required to use separate contexts to code the separate syntax elements when performing context adaptive coding. Accordingly, while the separate syntax elements may reduce the size of a partition mode table, such elements may be inefficient in terms of bit costs and computational costs.

As noted above, aspects of this disclosure relate to reducing or eliminating the need for additional syntax elements when indicating a partition mode, including when indicating an SDIP mode. For example, according to some aspects of this disclosure, video encoder 20 may indicate all partition modes, including SDIP modes, using one or more partition mode tables. That is, video encoder 20 may not implement separate syntax elements to indicate partition modes. Incorporating all partition modes in a partition mode table, including SDIP modes, may be more computationally efficient, as video encoder 20 need not use separate contexts to code separate partition mode syntax elements. Moreover, incorporating all partition modes in a partition mode table, including SDIP modes, may present a bit savings versus using separate syntax elements for certain partition modes.

Aspects of this disclosure also relate to predicting a block of video data using asymmetric SDIP partitions. For example, in addition to symmetric SDIP modes, video encoder 20 may use a variety of asymmetric SDIP modes to asymmetrically partition a block of data (a CU) for purposes of prediction. In some examples, the asymmetric SIDP modes may be included in the unified partition mode table discussed above. In other examples, separate signaling may be associated with the asymmetric SDIP modes. For example, syntax data included for a block may include data indicating whether the block is partitioned using SDIP, and if so, whether the block is partitioned using symmetric or asymmetric SDIP.

Following intra-predictive or inter-predictive coding using the PUs of a CU, video encoder 20 may calculate residual data for the TUs of the CU. The PUs may comprise syntax data describing a method or mode of generating predictive pixel data in the spatial domain (also referred to as the pixel domain) and the TUs may comprise coefficients in the transform domain following application of a transform, e.g., a discrete cosine transform (DCT), an integer transform, a wavelet transform, or a conceptually similar transform to residual video data. The residual data may correspond to pixel differences between pixels of the unencoded picture and prediction values corresponding to the PUs. Video encoder 20 may form the TUs including the residual data for the CU, and then transform the TUs to produce transform coefficients for the CU.

According to aspects of this disclosure, video encoder 20 may use TUs having the same sizes as corresponding asymmetric SDIP partitions, and thus, different sizes from each other. In other examples, the TUs may each have equal sizes to each other, and thus, potentially be different from the sizes of the asymmetric SDIP partitions (although one of the TUs may be the same size as a corresponding asymmetric SDIP partition). In some examples, the TUs may be represented using a residual quadtree (RQT), which may indicate that one or more of the TUs are smaller than the smallest asymmetric SDIP partition of the current block.

Following any transforms to produce transform coefficients, video encoder 20 may perform quantization of the transform coefficients. Quantization generally refers to a process in which transform coefficients are quantized to possibly reduce the amount of data used to represent the coefficients, providing further compression. The quantization process may reduce the bit depth associated with some or all of the coefficients. For example, an n-bit value may be rounded down to an m-bit value during quantization, where n is greater than m.

Following quantization, the video encoder may scan the transform coefficients, producing a one-dimensional vector from the two-dimensional matrix including the quantized transform coefficients. The scan may be designed to place higher energy (and therefore lower frequency) coefficients at the front of the array and to place lower energy (and therefore higher frequency) coefficients at the back of the array. In some examples, video encoder 20 may utilize a predefined scan order to scan the quantized transform coefficients to produce a serialized vector that can be entropy encoded. In other examples, video encoder 20 may perform an adaptive scan.

After scanning the quantized transform coefficients to form a one-dimensional vector, video encoder 20 may entropy encode the one-dimensional vector, e.g., according to context-adaptive variable length coding (CAVLC), context-adaptive binary arithmetic coding (CABAC), syntax-based context-adaptive binary arithmetic coding (SBAC), Probability Interval Partitioning Entropy (PIPE) coding or another entropy encoding methodology. Video encoder 20 may also entropy encode syntax elements associated with the encoded video data for use by video decoder 30 in decoding the video data.

Video encoder 20 may further send syntax data, such as block-based syntax data, frame-based syntax data, and group of pictures (GOP)-based syntax data, to video decoder 30, e.g., in a frame header, a block header, a slice header, or a GOP header. The GOP syntax data may describe a number of frames in the respective GOP, and the frame syntax data may indicate an encoding/prediction mode used to encode the corresponding frame.

Video decoder 30, upon receiving the coded video data, may perform a decoding pass generally reciprocal to the encoding pass described with respect to video encoder 20. According to aspects of this disclosure, for example, video decoder 30 may maintain one or more partition mode tables that include all partition modes. That is, video decoder 30 may not decode separate syntax elements, such as syntax elements associated with SDIP modes, when determining a partition mode for a particular CU. In some examples, video decoder 30 may maintain a partition mode table that includes one or more asymmetric SDIP modes.

Moreover, video decoder 30 may use TUs having the same sizes as corresponding asymmetric SDIP partitions, and thus, different sizes from each other. In other examples, the TUs may each have equal sizes to each other, and thus, potentially be different from the sizes of the asymmetric SDIP partitions (although one of the TUs may be the same size as a corresponding asymmetric SDIP partition). In some examples, the TUs may be represented using a residual quadtree (RQT), which may indicate that one or more of the TUs are smaller than the smallest asymmetric SDIP partition of the current block.

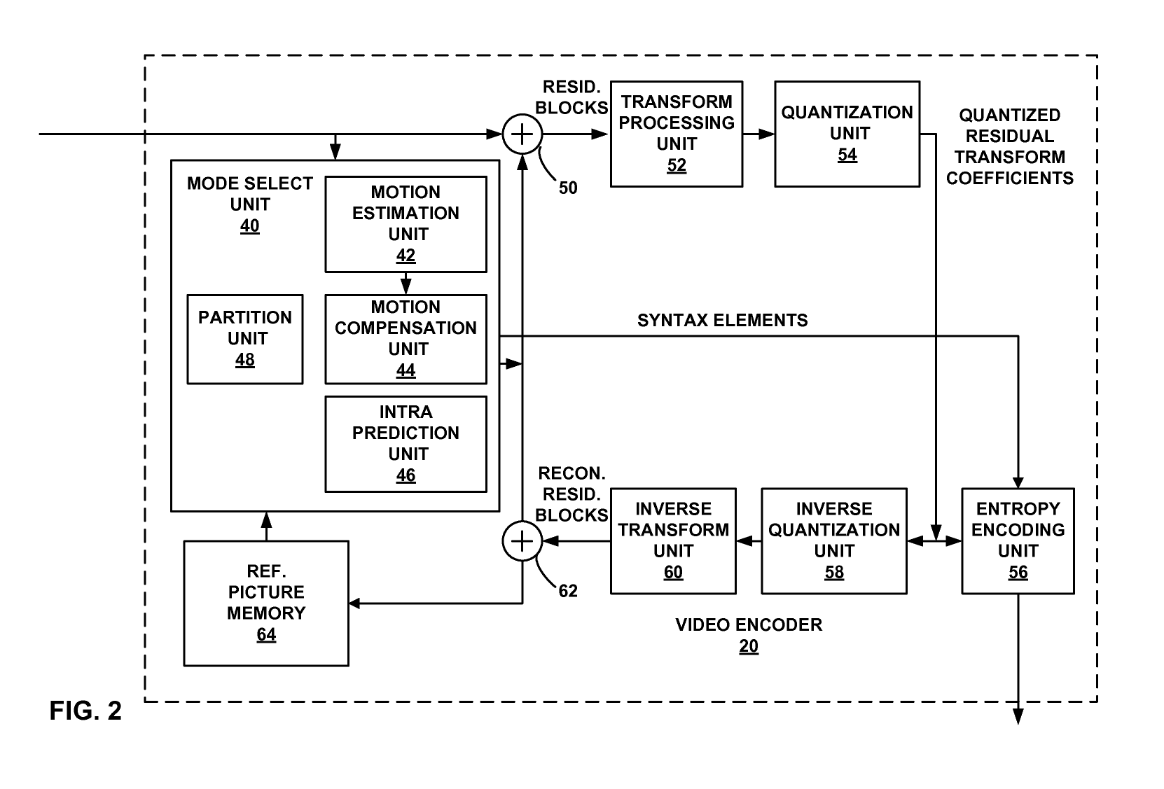

FIG. 2 is a block diagram illustrating an example of a video encoder 20 that may use techniques for intra-prediction coding as described in this disclosure. The video encoder 20 will be described in the context of HEVC coding for purposes of illustration, but without limitation of this disclosure as to other coding standards or methods that may require scanning of transform coefficients.

Video encoder 20 may perform intra- and inter-coding of video blocks within video slices. Intra-coding relies on spatial prediction to reduce or remove spatial redundancy in video within a given video frame or picture. Inter-coding relies on temporal prediction to reduce or remove temporal redundancy in video within adjacent frames or pictures of a video sequence. Intra-mode (I mode) may refer to any of several spatial based compression modes. Inter-modes, such as uni-directional prediction (P mode) or bi-prediction (B mode), may refer to any of several temporal-based compression modes.

As shown in FIG. 2, video encoder 20 receives a current video block within a video frame to be encoded. In the example of FIG. 2, video encoder 20 includes mode select unit 40, reference picture memory 64, summer 50, transform processing unit 52, quantization unit 54, and entropy encoding unit 56. Mode select unit 40, in turn, includes motion compensation unit 44, motion estimation unit 42, intra-prediction unit 46, and partition unit 48. For video block reconstruction, video encoder 20 also includes inverse quantization unit 58, inverse transform unit 60, and summer 62. A deblocking filter (not shown in FIG. 2) may also be included to filter block boundaries to remove blockiness artifacts from reconstructed video. If desired, the deblocking filter would typically filter the output of summer 62. Additional filters (in loop or post loop) may also be used in addition to the deblocking filter. Such filters are not shown for brevity, but if desired, may filter the output of summer 50 (as an in-loop filter).

During the encoding process, video encoder 20 receives a video frame or slice to be coded. The frame or slice may be divided into multiple video blocks. Motion estimation unit 42 and motion compensation unit 44 perform inter-predictive coding of the received video block relative to one or more blocks in one or more reference frames to provide temporal compression. Intra-prediction unit 46 may alternatively perform intra-predictive coding of the received video block relative to one or more neighboring blocks in the same frame or slice as the block to be coded to provide spatial compression. Video encoder 20 may perform multiple coding passes, e.g., to select an appropriate coding mode for each block of video data.

Moreover, partition unit 48 may partition blocks of video data into sub-blocks, based on evaluation of previous partitioning schemes in previous coding passes. For example, partition unit 48 may initially partition a frame or slice into LCUs, and partition each of the LCUs into sub-CUs based on rate-distortion analysis (e.g., rate-distortion optimization). Mode select unit 40 may further produce a quadtree data structure indicative of partitioning of an LCU into sub-CUs. Leaf-node CUs of the quadtree may include one or more PUs and one or more TUs.

Mode select unit 40 may select one of the coding modes, intra or inter, e.g., based on error results, and provides the resulting intra- or inter-coded block to summer 50 to generate residual block data and to summer 62 to reconstruct the encoded block for use as a reference frame. Mode select unit 40 also provides syntax elements, such as motion vectors, intra-mode indicators, partition information, and other such syntax information, to entropy encoding unit 56.

Motion estimation unit 42 and motion compensation unit 44 may be highly integrated, but are illustrated separately for conceptual purposes. Motion estimation, performed by motion estimation unit 42, is the process of generating motion vectors, which estimate motion for video blocks. A motion vector, for example, may indicate the displacement of a PU of a video block within a current video frame or picture relative to a predictive block within a reference frame (or other coded unit) relative to the current block being coded within the current frame (or other coded unit). A predictive block is a block that is found to closely match the block to be coded, in terms of pixel difference, which may be determined by sum of absolute difference (SAD), sum of square difference (SSD), or other difference metrics. In some examples, video encoder 20 may calculate values for sub-integer pixel positions of reference pictures stored in reference picture memory 64. For example, video encoder 20 may interpolate values of one-quarter pixel positions, one-eighth pixel positions, or other fractional pixel positions of the reference picture. Therefore, motion estimation unit 42 may perform a motion search relative to the full pixel positions and fractional pixel positions and output a motion vector with fractional pixel precision.

Motion estimation unit 42 calculates a motion vector for a PU of a video block in an inter-coded slice by comparing the position of the PU to the position of a predictive block of a reference picture. The reference picture may be selected from a first reference picture list (List 0) or a second reference picture list (List 1), each of which identify one or more reference pictures stored in reference picture memory 64. Motion estimation unit 42 sends the calculated motion vector to entropy encoding unit 56 and motion compensation unit 44.

Motion compensation, performed by motion compensation unit 44, may involve fetching or generating the predictive block based on the motion vector determined by motion estimation unit 42. Again, motion estimation unit 42 and motion compensation unit 44 may be functionally integrated, in some examples. Upon receiving the motion vector for the PU of the current video block, motion compensation unit 44 may locate the predictive block to which the motion vector points in one of the reference picture lists. Summer 50 forms a residual video block by subtracting pixel values of the predictive block from the pixel values of the current video block being coded, forming pixel difference values, as discussed below. In general, motion estimation unit 42 performs motion estimation relative to luma components, and motion compensation unit 44 uses motion vectors calculated based on the luma components for both chroma components and luma components. Mode select unit 40 may also generate syntax elements associated with the video blocks and the video slice for use by video decoder 30 in decoding the video blocks of the video slice.

Intra-prediction unit 46 may intra-predict a current block, as an alternative to the inter-prediction performed by motion estimation unit 42 and motion compensation unit 44, as described above. In particular, intra-prediction unit 46 may determine an intra-prediction mode to use to encode a current block. In some examples, intra-prediction unit 46 may encode a current block using various intra-prediction modes, e.g., during separate encoding passes, and intra-prediction unit 46 (or mode select unit 40, in some examples) may select an appropriate intra-prediction mode to use from the tested modes.

For example, intra-prediction unit 46 may calculate rate-distortion values using a rate-distortion analysis for the various tested intra-prediction modes, and select the intra-prediction mode having the best rate-distortion characteristics among the tested modes. Rate-distortion analysis generally determines an amount of distortion (or error) between an encoded block and an original, unencoded block that was encoded to produce the encoded block, as well as a bitrate (that is, a number of bits) used to produce the encoded block. Intra-prediction unit 46 may calculate ratios from the distortions and rates for the various encoded blocks to determine which intra-prediction mode exhibits the best rate-distortion value for the block.

According to aspects of this disclosure, in some instances, intra-prediction unit 46 may select an SDIP mode when predicting a block of video data. For example, as noted above, intra-prediction unit 46 may perform a rate-distortion analysis to determine an intra-prediction mode having the best-rate distortion characteristics. In addition, intra-prediction unit 46 may perform a rate-distortion analysis to determine a partitioning of a CU into one or more PUs for intra-prediction. That is, assuming that the size of a particular CU is 2N×2N, intra-prediction unit 46 may determine whether to predict the CU as a whole using a 2N×2N PU, predict the CU using four equally sized N×N PUs, or whether to predict the CU using a number of parallel PUs (e.g., using SDIP modes 2N×hN or nN×2N). While described with respect to intra-prediction unit 46, the partitioning of a CU may (or alternatively) be determined by partition unit 48.

In any case, according to aspects of this disclosure, intra-prediction unit 46 may use one or more partition mode tables to indicate a particular partitioning mode, regardless of the partitioning mode. For example, intra-prediction unit 46 may indicate a prediction partitioning mode for partitioning a CU into one or more PUs using a partition mode table, including for SDIP modes.

In some instances, intra-prediction unit 46 may be restricted from using certain intra-prediction modes during coding. For example, intra-prediction unit 46 may be restricted from using one or more intra-prediction modes unless predetermined criteria have been met. In an example for purposes of illustration, intra-prediction unit 46 may not use SDIP modes unless a CU is larger than a predetermined size (e.g., 64×64, 32×32, and the like). In such examples, according to aspects of this disclosure and as described in greater detail below with respect to Table III, the partition mode table may include separate mappings based on the criteria. That is, for example, a particular partition mode may map to a first bin string for a CUs that are equal to or larger than 64×64 and a second, different bin string for CUs that are smaller than 64×64.

In some instances, intra-mode prediction unit 46 may maintain more than one partition mode table. For example, intra-prediction unit 46 may maintain a single partition mode table for all slices (e.g., I-slices, P-slices, and B-slices). In another example, however, intra-prediction unit 46 may maintain separate partition mode tables for different slice types. That is, intra-prediction unit 46 may maintain a separate table for I-slices than is used for P-slices and/or B-slices.

In instances in which intra-prediction unit 46 maintains more than one partition mode table, intra-prediction unit 46 may select a partition mode table based on a variety of factors. For example, in instances in which intra-prediction unit 46 maintains separate tables for different slice types (e.g., I/P/B slices), intra-prediction unit 46 may select a partition mode table based on the slice type of the block being coded. In other examples, intra-prediction unit 46 may select a partition mode table based on picture size, frame rate, quantization parameter (QP), CU depth, and the like. Such information is generally known to both video encoder 20 and video decoder 30. Accordingly, selection criteria need not be included in the bitstream. However, in other examples, data for selection of a partition mode table may be signaled in the bitstream using one or more syntax elements, such one or more high level syntax elements included in a parameter set.

According to aspects of this disclosure, intra-prediction unit 46 may also partition a CU for purposes of prediction using an asymmetric SDIP partition. For example, in addition to symmetric SDIP modes, intra-prediction unit 46 may use a variety of asymmetric SDIP modes to asymmetrically partition a block of data (a CU) for purposes of prediction. In such examples, intra-prediction unit 46 may use a unified partition mode table that includes the asymmetric SIDP modes for signaling a particular asymmetric SDIP mode in the bitstream.

Video encoder 20 forms a residual video block by subtracting the prediction data from mode select unit 40 from the original video block being coded. Summer 50 represents the component or components that perform this subtraction operation.

Transform processing unit 52 applies a transform, such as a discrete cosine transform (DCT) or a conceptually similar transform, to the residual block, producing a video block comprising residual transform coefficient values. Transform processing unit 52 may perform other transforms which are conceptually similar to DCT. Wavelet transforms, integer transforms, sub-band transforms or other types of transforms could also be used. In any case, transform processing unit 52 applies the transform to the residual block, producing a block of residual transform coefficients. The transform may convert the residual information from a pixel value domain to a transform domain, such as a frequency domain.

According to aspects of this disclosure, transform processing unit 52 may use TUs having the same sizes as corresponding asymmetric SDIP partitions, and thus, different sizes from each other. In other examples, the TUs may each have equal sizes to each other, and thus, potentially be different from the sizes of the asymmetric SDIP partitions (although one of the TUs may be the same size as a corresponding asymmetric SDIP partition). In some examples, the TUs may be represented using a residual quadtree (RQT), which may indicate that one or more of the TUs are smaller than the smallest asymmetric SDIP partition of the current block.

In any case, transform processing unit 52 may send the resulting transform coefficients to quantization unit 54. Quantization unit 54 quantizes the transform coefficients to further reduce bit rate. The quantization process may reduce the bit depth associated with some or all of the coefficients. The degree of quantization may be modified by adjusting a quantization parameter. In some examples, quantization unit 54 may then perform a scan of the matrix including the quantized transform coefficients. Alternatively, entropy encoding unit 56 may perform the scan.

Following quantization, entropy encoding unit 56 entropy codes the quantized transform coefficients. For example, entropy encoding unit 56 may perform context adaptive variable length coding (CAVLC), context adaptive binary arithmetic coding (CABAC), syntax-based context-adaptive binary arithmetic coding (SBAC), probability interval partitioning entropy (PIPE) coding or another entropy coding technique. In the case of context-based entropy coding, context may be based on neighboring blocks. Following the entropy coding by entropy encoding unit 56, the encoded bitstream may be transmitted to another device (e.g., video decoder 30) or archived for later transmission or retrieval.

According to aspects of this disclosure, entropy encoding unit 56, or another unit responsible for coding (e.g., such as a fixed length coder), may encode an indication that a block of video data is coded using an SDIP mode using a partition mode table. For example, as noted above, video encoder 20 may maintain one or more partition mode tables (also referred to as codeword mapping tables) that map partition modes to syntax elements, such as binarized values representative of the partition modes. Accordingly, entropy coding unit 56 may entropy encode one or more bin strings that correspond to an entry in a partition mode table.

Inverse quantization unit 58 and inverse transform unit 60 apply inverse quantization and inverse transformation, respectively, to reconstruct the residual block in the pixel domain, e.g., for later use as a reference block. Motion compensation unit 44 may calculate a reference block by adding the residual block to a predictive block of one of the frames of reference picture memory 64. Motion compensation unit 44 may also apply one or more interpolation filters to the reconstructed residual block to calculate sub-integer pixel values for use in motion estimation. Summer 62 adds the reconstructed residual block to the motion compensated prediction block produced by motion compensation unit 44 to produce a reconstructed video block for storage in reference picture memory 64. The reconstructed video block may be used by motion estimation unit 42 and motion compensation unit 44 as a reference block to inter-code a block in a subsequent video frame.

In this manner, video encoder 20 represents an example of a video encoder that may code an indication that a block of video data is coded using a short distance intra-prediction (SDIP) mode, where the indication corresponds to a value of a partition mode table, and code the block of video data using the SDIP mode.

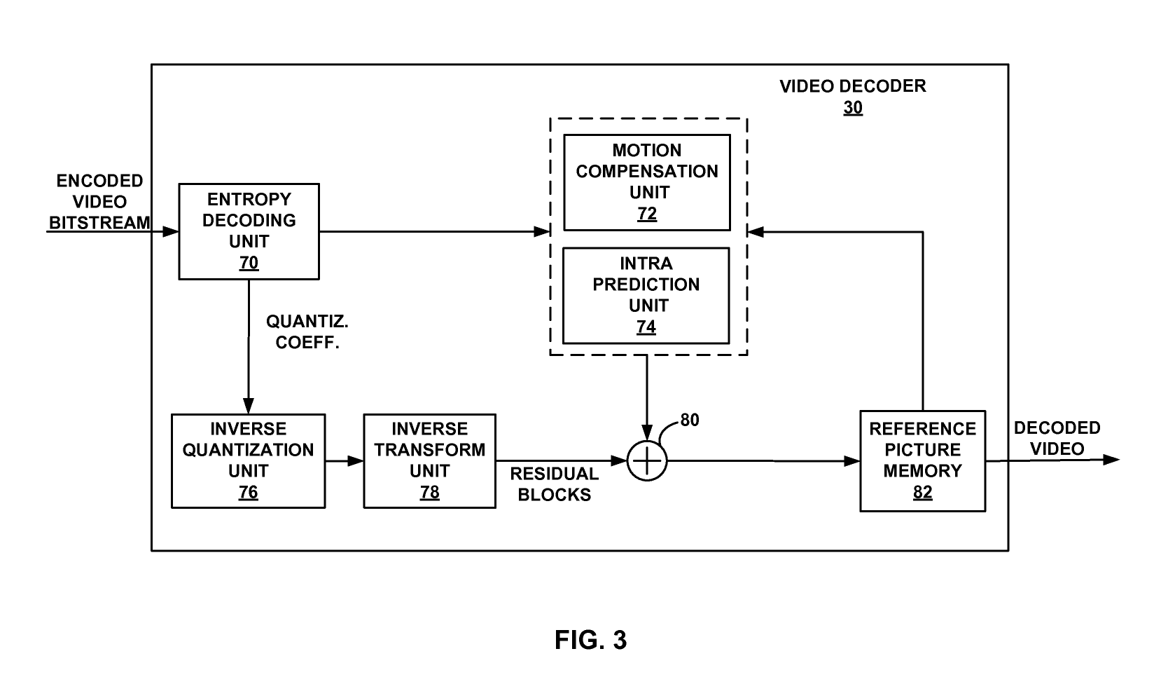

FIG. 3 is a block diagram illustrating an example of video decoder 30 that may implement techniques for intra-prediction coding as described in this disclosure. In the example of FIG. 3, video decoder 30 includes an entropy decoding unit 70, motion compensation unit 72, intra prediction unit 74, inverse quantization unit 76, inverse transformation unit 78, reference picture memory 82 and summer 80.

During the decoding process, video decoder 30 receives an encoded video bitstream that represents video blocks of an encoded video slice and associated syntax elements from video encoder 20. Entropy decoding unit 70 of video decoder 30 entropy decodes the bitstream to generate quantized coefficients, motion vectors or intra-prediction mode indicators, and other syntax elements. Entropy decoding unit 70 forwards the motion vectors to and other syntax elements to motion compensation unit 72. Video decoder 30 may receive the syntax elements at the video slice level and/or the video block level.

For example, by way of background, video decoder 30 may receive compressed video data that has been encapsulated for transmission via a network into so-called “network abstraction layer units” or NAL units. Each NAL unit may include a header that identifies a type of data stored to the NAL unit. There are two types of data that are commonly stored to NAL units. The first type of data stored to a NAL unit is video coding layer (VCL) data, which includes the compressed video data. The second type of data stored to a NAL unit is referred to as non-VCL data, which includes additional information such as parameter sets that define header data common to a large number of NAL units and supplemental enhancement information (SEI). For example, parameter sets may contain the sequence-level header information (e.g., in sequence parameter sets (SPS)) and the infrequently changing picture-level header information (e.g., in picture parameter sets (PPS)). The infrequently changing information contained in the parameter sets does not need to be repeated for each sequence or picture, thereby improving coding efficiency. In addition, the use of parameter sets enables out-of-band transmission of header information, thereby avoiding the need of redundant transmissions for error resilience.

According to aspects of this disclosure, entropy decoding unit 70, or another unit responsible for coding (such as a fixed length coder), may decode an indication that a block of video data is coded using an SDIP mode. The indication may correspond to an entry in a partition mode table. For example, as described below, video decoder 30 may maintain one or more partition mode tables (also referred to as codeword mapping tables) that map partition modes to syntax elements, such as binarized values representative of the partition modes. Accordingly, entropy decoding unit 70 may entropy decode one or more bin strings that correspond to an entry in a partition mode table, which represents a type of binarization table.

When the video slice is coded as an intra-coded (I) slice, intra prediction unit 74 may generate prediction data for a video block of the current video slice based on a signaled intra prediction mode and data from previously decoded blocks of the current frame or picture. According to aspects of this disclosure, in some instances, intra prediction unit 74 may select an SDIP mode when predicting a block of video data. For example, intra prediction unit 74 may use one or more partition mode tables to identify a particular partitioning mode based on a decoded bin string (from entropy decoding unit 70). The partition mode tables, according to aspects of this disclosure, may include SDIP modes.

In some instances, intra prediction unit 74 may be restricted from using certain intra-prediction modes during coding. For example, intra prediction unit 74 may be restricted from using one or more intra-prediction modes unless predetermined criteria have been met. In an example for purposes of illustration, intra prediction unit 74 may not use SDIP modes unless a CU is larger than a predetermined size (e.g., 64×64, 32×32, and the like). In such examples, according to aspects of this disclosure and as described in greater detail below with respect to Table III, the partition mode table may include separate mappings based on the criteria. That is, for example, a particular partition mode may map to a first bin string for a CUs that are equal to or larger than 64×64 and a second, different bin string for CUs that are smaller than 64×64.

In some instances, intra prediction unit 74 may maintain more than one partition mode table. For example, intra prediction unit 74 may maintain a single partition mode table for all slices (e.g., I-slices, P-slices, and B-slices). In another example, however, intra-prediction unit 74 may maintain separate partition mode tables for different slice types. That is, intra prediction unit 74 may maintain a separate table for I-slices than is used for P-slices and/or B-slices. As yet another example, intra-prediction unit 74 may maintain separate partition mode tables for CUs that are equal to or larger than 32×32 and for CUs that are smaller than 32×32.

In instances in which intra prediction unit 74 maintains more than one partition mode table, intra prediction unit 74 may select a partition mode table based on a variety of factors. For example, in instances in which intra prediction unit 74 maintains separate tables for different slice types (e.g., I/P/B slices), intra prediction unit 74 may select a partition mode table based on the slice type of the block being coded. In other examples, intra-prediction unit 74 may select a partition mode table based on picture size, frame rate, quantization parameter (QP), CU depth, and the like.

According to aspects of this disclosure, intra-prediction unit 74 may also partition a CU for purposes of prediction using an asymmetric SDIP partition. For example, in addition to symmetric SDIP modes, intra-prediction unit 74 may use a variety of asymmetric SDIP modes to asymmetrically partition a block of data (a CU) for purposes of prediction. In such examples, intra-prediction unit 74 may use a unified partition mode table that includes the asymmetric SIDP modes to identify a particular asymmetric SDIP mode based on an indication received in the bitstream.

When the video frame is coded as an inter-coded (i.e., B, P or GPB) slice, motion compensation unit 72 produces predictive blocks for a video block of the current video slice based on the motion vectors and other syntax elements received from entropy decoding unit 70. The predictive blocks may be produced from one of the reference pictures within one of the reference picture lists. Video decoder 30 may construct the reference frame lists, List 0 and List 1, using default construction techniques based on reference pictures stored in reference picture memory 82.

Motion compensation unit 72 determines prediction information for a video block of the current video slice by parsing the motion vectors and other syntax elements, and uses the prediction information to produce the predictive blocks for the current video block being decoded. For example, motion compensation unit 72 uses some of the received syntax elements to determine a prediction mode (e.g., intra- or inter-prediction) used to code the video blocks of the video slice, an inter-prediction slice type (e.g., B slice, P slice, or GPB slice), construction information for one or more of the reference picture lists for the slice, motion vectors for each inter-encoded video block of the slice, inter-prediction status for each inter-coded video block of the slice, and other information to decode the video blocks in the current video slice.

Motion compensation unit 72 may also perform interpolation based on interpolation filters. Motion compensation unit 72 may use interpolation filters as used by video encoder 20 during encoding of the video blocks to calculate interpolated values for sub-integer pixels of reference blocks. In this case, motion compensation unit 72 may determine the interpolation filters used by video encoder 20 from the received syntax elements and use the interpolation filters to produce predictive blocks.

Inverse quantization unit 76 inverse quantizes, i.e., de-quantizes, the quantized transform coefficients provided in the bitstream and decoded by entropy decoding unit 70. The inverse quantization process may include use of a quantization parameter QP_{Y} calculated by video decoder 30 for each video block in the video slice to determine a degree of quantization and, likewise, a degree of inverse quantization that should be applied.

Inverse transform unit 78 applies an inverse transform, e.g., an inverse DCT, an inverse integer transform, or a conceptually similar inverse transform process, to the transform coefficients in order to produce residual blocks in the pixel domain. According to aspects of this disclosure, inverse transform unit 78 may use TUs having the same sizes as corresponding asymmetric SDIP partitions, and thus, different sizes from each other. In other examples, the TUs may each have equal sizes to each other, and thus, potentially be different from the sizes of the asymmetric SDIP partitions (although one of the TUs may be the same size as a corresponding asymmetric SDIP partition). In some examples, the TUs may be represented using a residual quadtree (RQT), which may indicate that one or more of the TUs are smaller than the smallest asymmetric SDIP partition of the current block.

After motion compensation unit 72 generates the predictive block for the current video block based on the motion vectors and other syntax elements, video decoder 30 forms a decoded video block by summing the residual blocks from inverse transform unit 78 with the corresponding predictive blocks generated by motion compensation unit 72. Summer 80 represents the component or components that perform this summation operation. If desired, a deblocking filter may also be applied to filter the decoded blocks in order to remove blockiness artifacts. Other loop filters (either in the coding loop or after the coding loop) may also be used to smooth pixel transitions, or otherwise improve the video quality. The decoded video blocks in a given frame or picture are then stored in reference picture memory 82, which stores reference pictures used for subsequent motion compensation. Reference picture memory 82 also stores decoded video for later presentation on a display device, such as display device 32 of FIG. 1.

In this manner, video decoder 30 of FIG. 3 represents an example of a video decoder that implements a method including coding an indication that a block of video data is coded using a short distance intra-prediction (SDIP) mode, where the indication corresponds to a value of a partition mode table, and coding the block of video data using the SDIP mode.

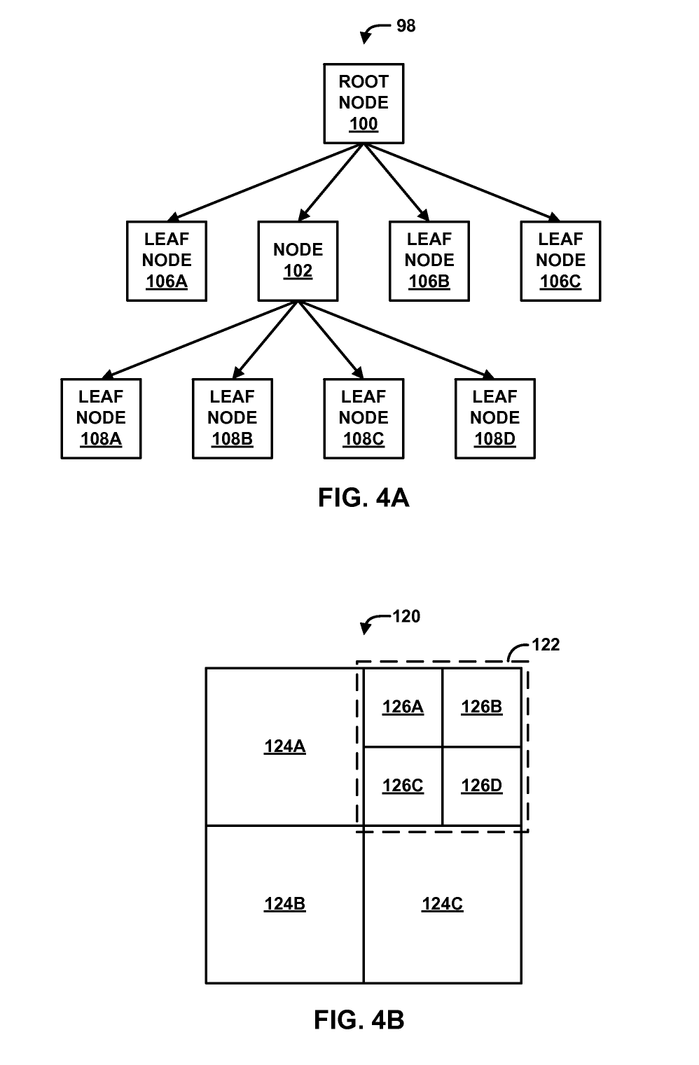

FIGS. 4A and 4B are conceptual diagrams illustrating an example quadtree 98 and a corresponding largest coding unit 120. FIG. 4A depicts an example quadtree 98, which includes nodes arranged in a hierarchical fashion. The quadtree 98 may be associated with, for example, a treeblock according to the proposed HEVC standard. Each node in a quadtree, such as quadtree 98, may be a leaf node with no children, or have four child nodes. In the example of FIG. 4A, quadtree 98 includes root node 100. Root node 100 has four child nodes, including leaf nodes 106A-106C (leaf nodes 106) and node 102. Because node 102 is not a leaf node, node 102 includes four child nodes, which in this example, are leaf nodes 108A-108D (leaf nodes 108).

Quadtree 98 may include data describing characteristics of a corresponding largest coding unit (LCU), such as LCU 120 in this example. For example, quadtree 98, by its structure, may describe splitting of the LCU into sub-CUs. Assume that LCU 120 has a size of 2N×2N. LCU 120, in this example, has four sub-CUs 124A-124C (sub-CUs 124) and 122, each of size N×N. Sub-CU 122 is further split into four sub-CUs 126A-126D (sub-CUs 126), each of size N/2×N/2. The structure of quadtree 98 corresponds to the splitting of LCU 120, in this example. That is, root node 100 corresponds to LCU 120, leaf nodes 106 correspond to sub-CUs 124, node 102 corresponds to sub-CU 122, and leaf nodes 108 correspond to sub-CUs 126.

Data for nodes of quadtree 98 may describe whether the CU corresponding to the node is split. If the CU is split, four additional nodes may be present in quadtree 98. In some examples, a node of a quadtree may be implemented similar to the following pseudocode:

```
quadtree_node {
    boolean split_flag(1);
    // signaling data
    if (split_flag) {
        quadtree_node child1;
        quadtree_node child2;
        quadtree_node child3;
        quadtree_node child4;
    }
}
```

The split_flag value may be a one-bit value representative of whether the CU corresponding to the current node is split. If the CU is not split, the split_flag value may be ‘0’, while if the CU is split, the split_flag value may be ‘1’. With respect to the example of quadtree 98, an array of split flag values may be 101000000.

As noted above, CU depth may refer to the extent to which an LCU, such as LCU 120 has been divided. For example, root node 100 may correspond to CU depth zero, while node 102 and leaf nodes 106 may correspond to CU depth one. In addition, leaf nodes 108 may correspond to CU depth two. According to aspects of this disclosure, CU and/or TU depth may be used as context for entropy coding certain syntax elements. In an example for purposes of explanation, one or more syntax elements associated with leaf node 106A may be entropy coded using a different context model than leaf node 108A, because leaf node 106A is located at depth one, while leaf node 108A is located at depth two.

While FIG. 4A illustrates an example of a CU quadtree, it should be understood that a similar quadtree may be applied to TUs of a leaf-node CU. That is, a leaf-node CU may include a TU quadtree (referred to as a residual quad tree (RQT)) that describes partitioning of TUs for the CU. A TU quadtree may generally resemble a CU quadtree, except that the TU quadtree may signal intra-prediction modes for TUs of the CU individually.

In some examples, a video coder (such as video encoder 20 (FIGS. 1 and 2) or video decoder 30 (FIGS. 1 and 3) may select a partition mode table based on a CU depth. That is, for instance, certain partition modes such as SDIP modes may only be available for predicting CUs of a certain depth. In this example, the video coder may maintain one or more partition mode tables that include the depth restriction. For example, the video coder may maintain a partition mode table that includes a mapping of SDIP modes for CUs having a CU depth of one or less (assuming root node 100 is located at CU depth zero and node 102 and leaf nodes 106 are located at depth one), but that does not include a mapping of SDIP modes to syntax elements for CUs having CU depth that is more than one (e.g., leaf nodes 108 at CU depth two).

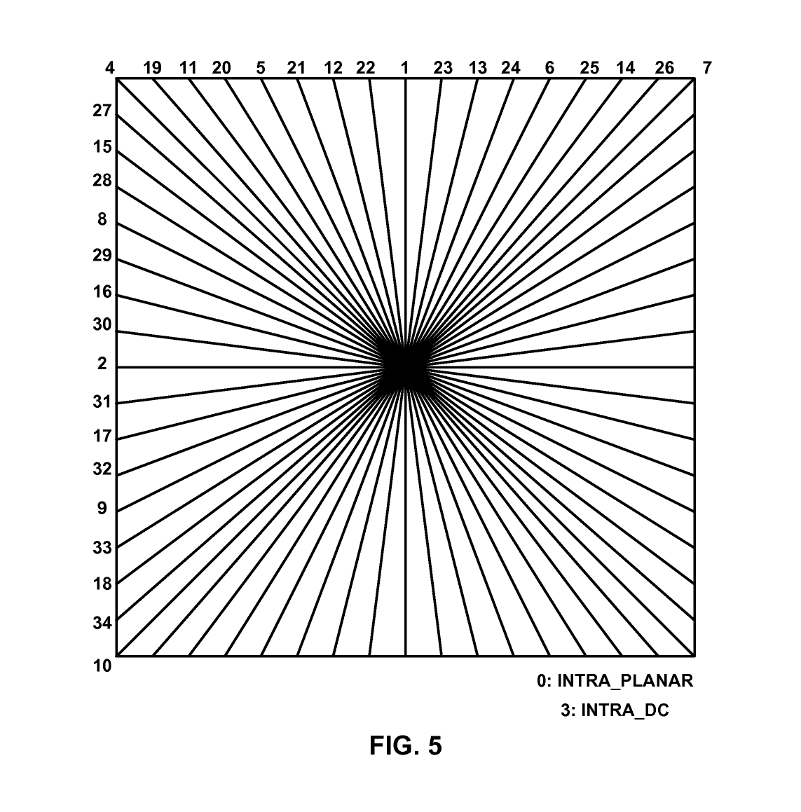

FIG. 5 generally illustrates the prediction directions associated with directional intra-prediction modes. For example, as noted above, the emerging HEVC standard may include thirty five intra-prediction modes, including a planar mode (mode 0), a DC mode (mode 1) and 33 directional prediction modes (modes 2-34). With planar mode, prediction is performed using a so-called “plane” function. With DC mode, prediction is performed based on an averaging of pixel values within the block. With a directional prediction mode, prediction is performed based on a neighboring block's reconstructed pixels along a particular direction (as indicated by the mode).

In some instances, a video encoder (such as video encoder 20) may signal an intra-mode for a block using a most probable mode (MPM) process. For example, video encoder 20 may identify up to two MPM candidates associated with blocks that neighbor the block currently being coded (e.g., a block that is positioned above the block currently being encoded and a block that is positioned to the left of the block currently being encoded). In the event that the two MPM candidates cannot be found (e.g., the blocks are not intra coded, the blocks are in a different slice or outside a picture boundary, the blocks have the same intra mode), video encoder 20 may substitute DC mode.

If the intra-mode for the block currently being encoded is equal to either of the MPM candidates, video encoder 20 may set a prev_infra_luma_pred_flag. In addition, video encoder 20 may set an mpm_idx flag to identify the matching MPM candidate. If, however, the intra-mode for the block currently being encoded is not equal to either of the MPM candidates, video encoder 20 may set a rem_intra_luma_pred_mode symbol to indicate which of the remaining intra-modes is equal to the intra-mode for the block currently being encoded.

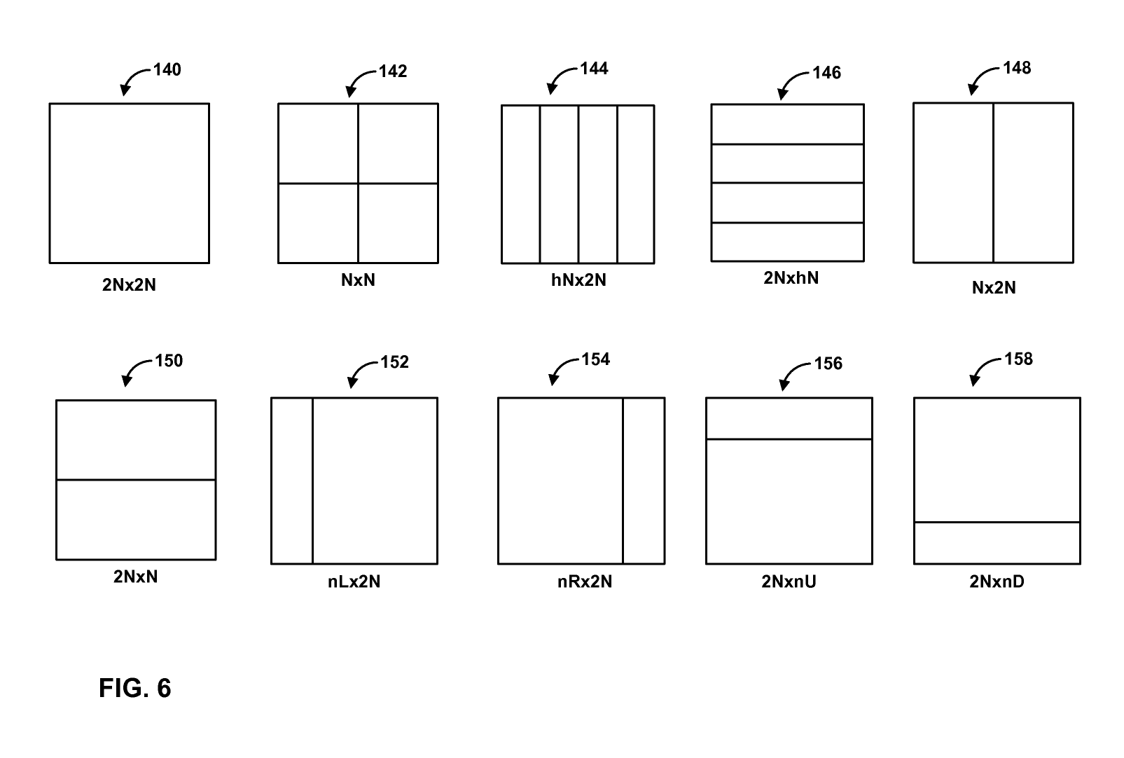

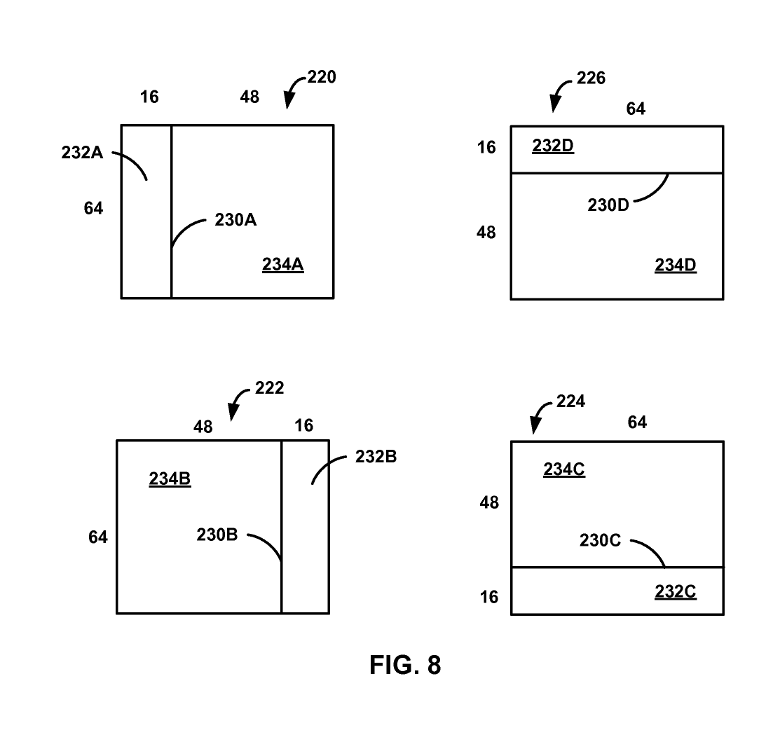

According to aspects of this disclosure, the intra-modes shown and described with respect to the example of FIG. 5 may be used in conjunction with one or more of the partitioning modes shown in FIGS. 6 and 8, including SDIP and/or asymmetric SDIP modes.

FIG. 6 generally illustrates partitioning modes (which may define PU sizes) that may be associated with prediction units. For example, assuming the size of a particular CU is 2N×2N, the CU may be predicted using partition modes 2N×2N (140), N×N (142), hN×2N (144), 2N×hN (146), N×2N (148), 2N×N (150), nL×2N (152), nR×2N (154), 2N×nU (156), and 2N×nD (158). The partition modes shown in the example of FIG. 5 are presented for purposes of illustration only, and other partition modes may be used to indicate the manner in which video data is predicted.

In some instances, a video coder (e.g., such as video encoder 20 and/or video decoder 30) may perform intra-prediction or inter-prediction using partition modes 140 and 142. For example, the video coder may predict a CU as a whole using the 2N×2N PU (partition mode 140). In another example, the video coder may predict the CU using four N×N sized PUs (partition mode 142), with each of the four sections having a potentially different prediction technique being applied.

In addition, with respect to intra-coding, the video coder may perform a technique referred to as short distance intra-prediction (SDIP). If SDIP is available, the CU may be predicted using parallel PUs (partition modes 144 and 146). That is, SDIP generally allows a CU to be divided into parallel PUs. By splitting a coding unit (CU) into non-square prediction units (PUs) the distances between the predicted and the reference pixels may be shortened. Accordingly, in some instances, the accuracy of intra prediction can be improved when applying a directional prediction method, such as directional prediction modes 2-34 shown in FIG. 5).

As an example, an 8×8 CU may be divided into four 8×2 PUs, where “N×M” refers to N pixels vertically and M pixels horizontally, in this example. The first PU may be predicted from neighboring pixels to the CU, the second PU may be predicted from neighboring pixels including pixels of the first PU, the third PU may be predicted from neighboring pixels including pixels of the second PU, and the fourth PU may be predicted from neighboring pixels including pixels of the third PU. In this manner, rather than predicting all pixels of the CU from pixels of neighboring, previously coded blocks to the CU, pixels within the CU may be used to predict other pixels within the same CU, using SDIP.

In the example, shown in FIG. 6, a CU may be predicted with four SDIP PUs in a hN×2N arrangement (partition mode 144) where “h” represents one-half. In another example, a CU may be predicted with four SDIP PUs in an 2N×hN arrangement (partition mode 146). The partitioning of the CU into SDIP PUs may be referred to as implementing SDIP partition modes. In other examples, additional prediction types may also be possible.

With respect to inter-coding, in addition to the symmetric partition modes 140 and 142, the video coder may implement a side-by-side arrangement of PUs (partition modes 148 and 150), or a variety of AMP (asymmetric motion partition) modes. With respect to the AMP modes, the video coder may asymmetrically partition a CU using partition modes nL×2N (152), nR×2N (154), 2N×nU (156), and 2N×nD (158). In asymmetric partitioning, one direction of a CU is not partitioned, while the other direction is partitioned into 25% and 75%. The portion of the CU corresponding to the 25% partition is indicated by an “n” followed by an indication of “Up”, “Down,” “Left,” or “Right.”

According to aspects of this disclosure, a video coder may indicate all partition modes shown in FIG. 6, including SDIP modes 144 and 146, using one or more partition mode tables. That is, a video encoder may not encode (and a video decoder may not decode) separate syntax elements to indicate partition modes, including SDIP modes 144 and 146. As noted above, incorporating all partition modes in a partition mode table, including SDIP modes, may present a bit savings versus using separate syntax elements for certain partition modes, and may also be more computationally efficient than using separate syntax elements due to a reduction in CABAC contexts required to code such separate syntax elements.

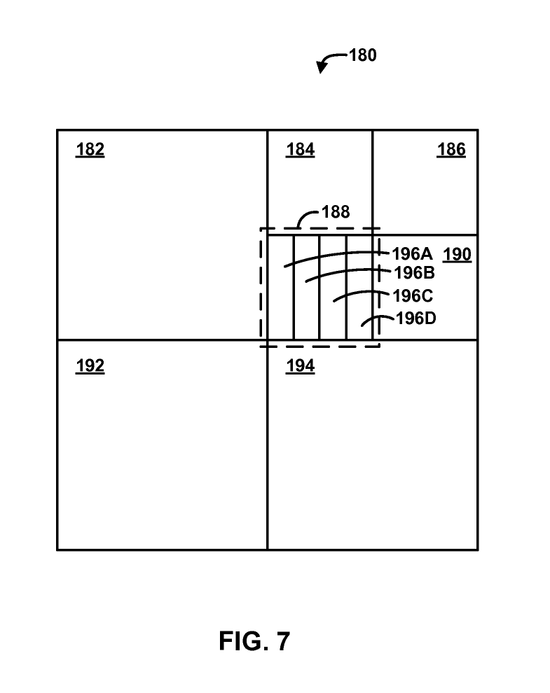

FIG. 7 is a conceptual diagram illustrating an example LCU 180 including an SDIP-predicted CU. In particular, LCU 180 includes sub-CUs 182, 184, 186, 188, 190, 192, and 194, in this example. Each of sub-CUs 182, 184, 186, 188, 190, 192, and 194 corresponds to a leaf node CU. A non-leaf node CU would include sub-CUs 184, 186, 188, and 190 as well, in this example. Each of the leaf node sub-CUs may be predicted according to a particular prediction mode. In this example, sub-CU 188 is predicted using SDIP. Accordingly, sub-CU 188 includes four PUs 196A-196D (PUs 196). As shown in this example, PUs 196 are horizontal PUs of sub-CU 188.

As noted above, certain aspects of this disclosure relate to reducing or eliminating the need for additional syntax elements when implementing SDIP. For example, according to some aspects of this disclosure, SDIP_Flag and SDIP_direction_Flag syntax elements may be eliminated. In this example, rather than using flags to signal SDIP partition information, the SDIP partition information may be incorporated in a partition mode table.

For example, Table I (below) is an example of a partition mode table that may be included in the HEVC test model HM that does not include SDIP modes. That is, Table I may be maintained by both video encoder 20 and video decoder 30.

TABLE I
Example Partition Mode Table

| | | | | Bin string | | |
|---|---|---|---|---|---|---|
| | | | | | cLog2CUSize == Log2MinCUSize | |
| Slice | Value of | Pred | | cLog2CUSize > | cLog2CUSize == 3 && | cLog2CUSize > 3 \|\| |
| type | pred_type | Mode | PartMode | Log2MinCUSize | !inter_4x4_enabled_flag | inter_4x4_enabled_flag |
| I | 0 | INTRA | PART_2Nx2N | — | 1 | 1 |
| | 1 | INTRA | PART_NxN | — | 0 | 0 |
| P/B | 0 | INTER | PART_2Nx2N | 0 1 | 0 1 | 0 1 |
| | 1 | INTER | PART_2NxN | 0 011 | 0 01 | 0 01 |
| | 2 | INTER | PART_Nx2N | 0 001 | 0 00 | 0 001 |
| | 4 | INTER | PART_2NxNU | 0 0100 | — | — |
| | 5 | INTER | PART_2NxND | 0 0101 | — | — |
| | 6 | INTER | PART_nLx2N | 0 0000 | — | — |
| | 7 | INTER | PART_nRx2N | 0 0001 | — | — |
| | 3 | INTER | PART_NxN | — | — | 0 000 |
| | 4 | INTRA | PART_2Nx2N | 1 | 11 | 11 |
| | 5 | INTRA | PART_NxN | — | 10 | 10 |

Accordingly, video encoder 20 and video decoder 30 may use Table I to map partition modes to syntax elements, i.e., the bin strings included on the right side of Table I. In this way, video encoder 20 and video decoder 30 may determine partition information, e.g., whether a CU is predicted using PUs sized 2N×2N and N×N for intra-coded blocks, or 2N×2N, 2N×N, N×2N, N×N for inter-coded blocks, using Table I.

However, Table I does not include SDIP modes. Rather, in some instances, SDIP modes may be signaled using a plurality of separate flags. As noted above, for example, video encoder 20 and video decoder 30 may use SDIP_Flag and SDIP_direction_Flag to identify SDIP modes. In this example, the SDIP_Flag and the SDIP_direction_Flag syntax elements must be provided in addition to the bin strings of Table 1.

Aspects of this disclosure relate to incorporating SDIP modes (e.g., SDIP modes hN×2N and 2N×hN) into a unified partition mode table. In one example, SDIP modes hN×2N and 2N×hN are represented by two entries in the partition mode table. An example of such an arrangement is provided in Table II below:

TABLE II
Unified Partition Mode Table

| | | | | Bin string | | |
|---|---|---|---|---|---|---|
| | | | | | cLog2CUSize == Log2MinCUSize | |
| Slice | Value of | Pred | | cLog2CUSize > | cLog2CUSize == 3 && | cLog2CUSize > 3 \|\| |
| type | pred_type | Mode | PartMode | Log2MinCUSize | !inter_4x4_enabled_flag | inter_4x4_enabled_flag |
| I | 0 | INTRA | PART_2Nx2N | 1 | 1 | 1 |
| | 2 | INTRA | PART_hNx2N | 01 | 010 | 010 |
| | 3 | INTRA | PART_2NxhN | 00 | 011 | 011 |
| | 1 | INTRA | PART_NxN | — | 00 | 00 |
| P/B | 0 | INTER | PART_2Nx2N | 0 1 | 0 1 | 0 1 |
| | 1 | INTER | PART_2NxN | 0 011 | 0 01 | 0 01 |
| | 2 | INTER | PART_Nx2N | 0 001 | 0 00 | 0 001 |
| | 4 | INTER | PART_2NxNU | 0 0100 | — | — |
| | 5 | INTER | PART_2NxND | 0 0101 | — | — |
| | 6 | INTER | PART_nLx2N | 0 0000 | — | — |
| | 7 | INTER | PART_nRx2N | 0 0001 | — | — |
| | 3 | INTER | PART_NxN | — | — | 0 000 |
| | 4 | INTRA | PART_2Nx2N | 11 | 11 | 11 |
| | 6 | INTRA | PART_hNx2N | 101 | 1010 | 1010 |
| | 7 | INTRA | PART_2NxhN | 100 | 1011 | 1011 |
| | 5 | INTRA | PART_NxN | — | 100 | 100 |

In the example of Table II, SDIP modes hN×2N and 2N×hN are represented by two entries in the partition mode table, and map to bin strings for I-slices as well as P- and B-slices.

It should be understood that the values provided in Table II are for purposes of explanation only. That is, for example, the assigned codewords (bin strings) are provided for purposes of explanation, and bin strings having different values may be used. For example, the “0” and “1” values in Table II (as well as values in other tables provided in this disclosure) may be toggled, or partially toggled (e.g., “0” and “1” may be switched for one or more modes, such as for hN×2N and 2N×hN, PART_hN×2N=00 and PART_{—}2N×hN=01). In another example, fixed length codes (FLC) may be used for the four intra modes (2N×2N, N×N, 2N×hN and hN×2N). The bin strings may represent binarized values representative of various partition modes, which may ultimately be entropy coded.

In some examples, SDIP modes may only be allowed in certain circumstances. For example, SDIP modes may be restricted from being used for certain sized CUs, CUs of certain depths, and the like. Accordingly, video encoder 20 and video decoder 30 may maintain partition mode tables that include the restrictions. Table III, shown below, illustrates an example in which SDIP modes are disabled for CUs having a width that is greater than 64 pixels.

TABLE III
Example Unified Partition Mode Table with Restriction

| | | | | Bin string | | | |
|---|---|---|---|---|---|---|---|
| | | | | cLog2CUSize > | | | |
| | | | | Log2MinCUSize | | cLog2CUSize == Log2MinCUSize | |
| | Value of | | | cLog2CUSize >= | cLog2CUSize < | cLog2CUSize == 3 && | cLog2CUSize > 3 \|\| |
| Slice type | pred_type | Pred Mode | PartMode | 64 | 64 | !inter_4x4_enabled_flag | inter_4x4_enabled_flag |
| I | 0 | INTRA | PART_2Nx2N | — | 1 | 1 | 1 |
| | 2 | INTRA | PART_hNx2N | — | 01 | 010 | 010 |
| | 3 | INTRA | PART_2NxhN | — | 00 | 011 | 011 |
| | 1 | INTRA | PART_NxN | — | — | 00 | 00 |
| P/B | 0 | INTER | PART_2Nx2N | 0 1 | 0 1 | 0 1 | 0 1 |
| | 1 | INTER | PART_2NxN | 0 011 | 0 011 | 0 01 | 0 01 |
| | 2 | INTER | PART_Nx2N | 0 001 | 0 001 | 0 00 | 0 001 |
| | 4 | INTER | PART_2NxNU | 0 0100 | 0 0100 | — | — |
| | 5 | INTER | PART_2NxND | 0 0101 | 0 0101 | — | — |
| | 6 | INTER | PART_nLx2N | 0 0000 | 0 0000 | — | — |
| | 7 | INTER | PART_nRx2N | 0 0001 | 0 0001 | — | — |
| | 3 | INTER | PART_NxN | — | — | — | 0 000 |
| | 4 | INTRA | PART_2Nx2N | 1 | 11 | 11 | 11 |
| | 6 | INTRA | PART_hNx2N | — | 101 | 1010 | 1010 |
| | 7 | INTRA | PART_2NxhN | — | 100 | 1011 | 1011 |
| | 5 | INTRA | PART_NxN | — | — | 100 | 100 |

In the example above, SDIP modes hN×2N and 2N×hN are disabled for CUs that are larger than 64×64. Accordingly, Table III does not include mappings for the SDIP modes for CUs that are equal to or larger than 64×64.

Other examples are also possible. That is, in the examples associated with Table II and Table III provided above, P- and B-slices share the same partition mode table, while I-slices have a different partition mode table. According to another aspect of this disclosure, a more adaptive and/or flexible mapping between slice type and partition mode tables may be provided. For example, in some instances, all three prediction possibilities (I/P/B) may share the same mode table, while in other instances, P-slices and B-slices may be have different corresponding partition mode tables.

According to other aspects of this disclosure, video encoder 20 and video decoder 30 may maintain multiple different partition mode tables. In an example, video encoder 20 or video decoder 30 may select an appropriate partition mode table based on the slice (or picture) picture being coded. That is, video encoder 20 or video decoder 30 may select a partition mode table based on side information that is available to video encoder 20 or video decoder 30. For example, selection of a partition mode table may be based on picture size, frame rate, quantization parameter (QP), CU depth, and the like.

In some examples, the selection criteria may be predetermined and may be implemented at both video encoder 20 and video decoder 30. Accordingly, in such examples, an indication of the selection criteria does not need to be included in the bitstream. In other examples, however, the partition mode table selection criteria may be signaled in the bitstream. For example, the selection criteria may be signaled using high level syntax, such as one or more syntax elements in a parameter set or header.

It should be understood that the tables described with respect to FIG. 7 are provided for purposes of illustration only. In other examples, a unified partition mode table may include more or fewer partition modes than those shown. For example, according to aspects of this disclosure, video encoder 20 and video decoder 30 may use a variety of asymmetric SDIP modes (as described in greater detail with respect to FIG. 8 below) to partition a block of video data for purposes of prediction. In such examples, a unified partition mode table (e.g., such as Table II or Table III above) may include a one or more asymmetric partition modes mapped to unique bin strings.

FIG. 8 is a conceptual diagram illustrating various examples of blocks 220-226 partitioned using asymmetric partition modes of SDIP. For example, FIG. 6 includes two symmetric SDIP modes 144 and 146. In the example of FIG. 8, each block 220-226 is partitioned into two rectangles, where each of blocks 220-226 is originally a 2N×2N block. One rectangle has a dimension (that is, length or width) of N/2 pixels, and another rectangle has the same dimension of 3N/2 pixels.

In this example, each of the blocks 220, 222, 224, and 226, is a 64×64 pixel block, although other sizes of blocks (e.g., 32×32, 16×16, 128×128, or the like) may also be partitioned in a similar manner. Block 220 is horizontally divided by vertical edge 230A into two PUs, one (1/2N)*2N PU 232A and one (3/2N)*2N PU 234A. Block 222 is horizontally divided by vertical edge 230B into two PUs, one (3/2N)*2N PU 234B and one (1/2N)*2N PU 232B. Block 224 is vertically divided by horizontal edge 230C into two PUs, one 2N*(3/2N) PU 234C and one 2N*(1/2N) PU 232C. Block 226 is vertically divided by horizontal edge 230D into two PUs, one 2N*(1/2N) PU 232D and one 2N*(3/2N) PU 234D. In this manner, the SDIP PUs 232, 234 of FIG. 8 may be referred to as asymmetric SDIP PUs.

As with conventional SDIP, each of the pixels of an asymmetric SDIP PU may share the same intra-prediction direction. Furthermore, asymmetric SDIP PUs need not necessarily have the same intra-prediction direction. For example, PU 232A may be predicted using a vertical intra-prediction mode (e.g., mode 1 in FIG. 5), while PU 234A may be predicted using a diagonal intra-prediction mode (e.g., mode 26 in FIG. 5).

In some examples, certain intra-prediction modes may be restricted for certain asymmetric PUs. For example, video coding devices (such as video encoder 20 or video decoder 30) may be configured to infer that relatively vertical asymmetric SDIP PUs, such as PUs 232A, 232B, 234A, and 234B, are not predicted using relatively horizontal intra-prediction modes (e.g., modes 27-10, extending from top to bottom of FIG. 5). Likewise, in another example, video coding devices may be configured to infer that relatively horizontal asymmetric SDIP PUs, such as PUs 232C, 232C, 234D, and 234D, are not predicted using relatively vertical intra-prediction modes (e.g., modes 4-7, extending from left to right of FIG. 5).

In some examples, transform unit sizes may be the same as the corresponding PU size. Thus, transform units for blocks 220-226 may have the same sizes as corresponding ones of PUs 232, 234. For example, for block 220, a (1/2N)*2N transform may be used for PU 232A, and a (3/2N)*2N transform may be used for PU 234A. Alternatively, in other examples, the same size transforms may be used for two PUs in asymmetric SDIP. For example, for block 220, a (1/2N)*2N transform may be used for PU 232A, and three (1/2N)*2N transforms may be used for PU 234A.

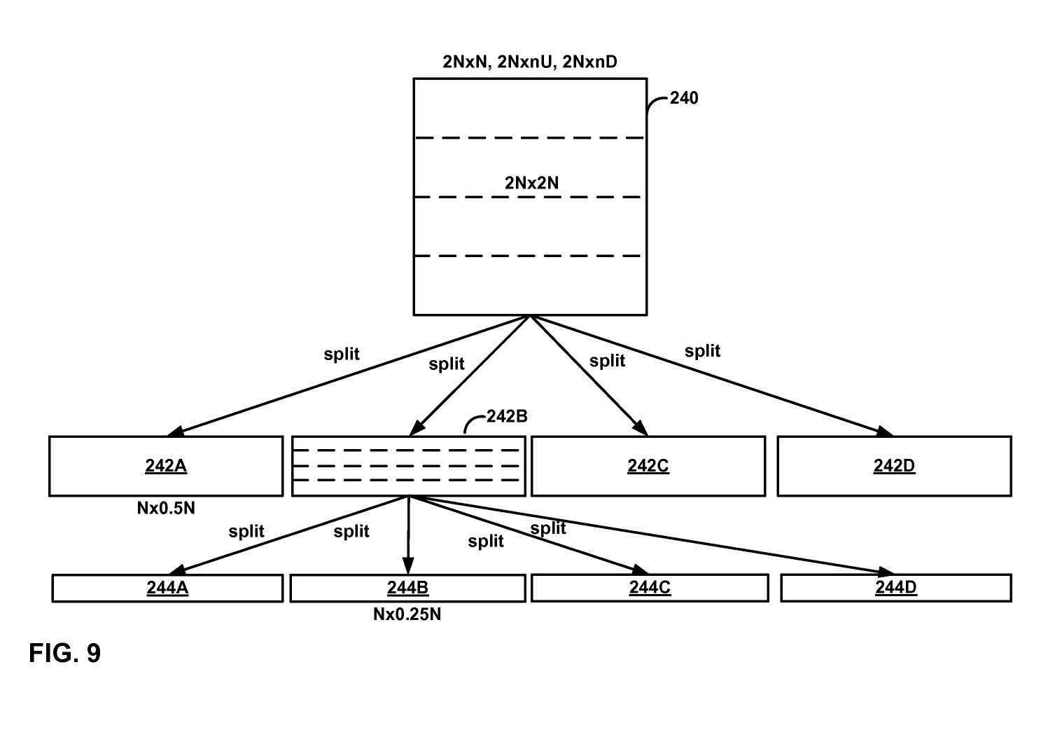

FIG. 9 is a conceptual diagram illustrating an example partitioning structure for non-square quadtree partitioning. As shown in FIG. 9, a block 240 may be partitioned using non-square quadtree transforms (NSQT). Generally, NSQT allows a block, such as a TU of a CU, to be partitioned into a first level of four non-square rectangles, any or all of which may be further partitioned into an additional level of four smaller, equally sized non-square rectangles. In the example of FIG. 9, a block 240 has size 2N×2N. The block may be partitioned into four 2N×(N/2) or (N/2)×2N rectangles 242A-242D. Any or all of these first level blocks 242 may be further partitioned into a second level of four smaller equally sized non-square blocks having size N×(N/4), e.g., blocks 244A-244D (blocks 244, not drawn to scale).

Although block 240 is illustrated in FIG. 9 as being partitioned into two levels of sub-blocks (242, 244), a block, such as block 240 may be partitioned into one level of blocks, which is not further partitioned. NSQT is generally used for partitioning transform units (TUs) of a block, where TUs include transform coefficients associated with residual data.

In some examples, an RQT tree structure, such as that shown in FIG. 9, may be used for an asymmetric SDIP partitioned CU. For example, for block 220 (FIG. 8), the transform for PU 232A may be either a level one TU such as a (1/2N)*2N TU (such as blocks 242), or four (1/4N)*N TUs, e.g., four level-two TUs (such as blocks 244). The RQT may include split flag syntax elements indicating whether, for each TU, the TU is further split into sub-TUs. In this manner, the split or not split decision may be indicated by a split flag.

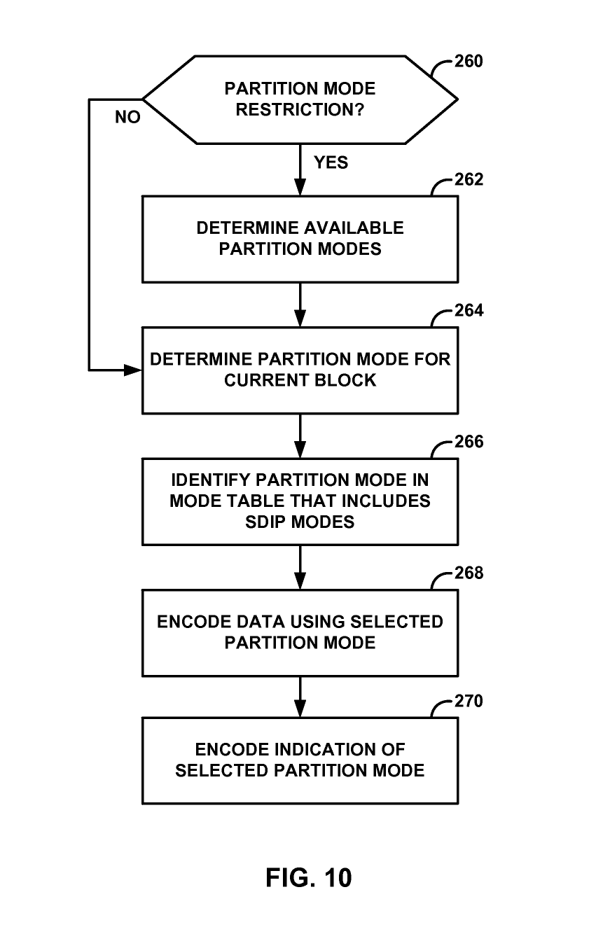

FIG. 10 is a flow diagram illustrating a technique of coding video data consistent with this disclosure. The example shown in FIG. 10 is generally described as being performed by video encoder 20 (FIGS. 1 and 2). It should be understood that, in some examples, the method of FIG. 10 may be carried out by a variety of other processors, processing units, hardware-based coding units such as encoder/decoders (CODECs), and the like.

In the example of FIG. 10, video encoder 20 initially determines whether there is a partition mode restriction when predicting video data (260). For example, as noted above, certain partition modes may be unavailable when predicting video data. That is, in some instances, SDIP modes may not be available for all CU sizes or depths. In any case, video encoder 20 may determine the partition modes that are available for partitioning a block of video data for purposes of prediction (262).

Video encoder 20 also determines a partition mode (from the available partition modes) for partitioning a block currently being encoded (264). In some examples, video encoder 20 may determine a partition mode based on a rate-distortion analysis. For example, video encoder 20 may calculate rate-distortion values using a rate-distortion process for various partition modes. Video encoder 20 may select the partition mode having the best rate-distortion characteristics among the tested partition modes.

After determining a partition mode for coding the current block, video encoder 20 may identify the selected partition mode in a partition mode table that includes SDIP modes, as described above (266). That is, according to aspects of this disclosure, video encoder 20 may identify the selected partition mode in a unified partition mode table that includes all of the partition modes, including SDIP modes.

Video encoder 20 also encodes the current block of video data using the selected partition mode (268). For example, video encoder 20 may generate residual prediction data based on a difference between the actual data and reference data. In some instances, video encoder 20 may intra-predict data using an SDIP mode and one of the directional intra-modes shown in FIG. 5. Video encoder 20 may also transform and quantize the residual prediction data. In addition to the video data, video encoder 20 encodes an indication of the selected partition mode (270). That is, video encoder 20 may encode a bin string that maps to the selected partition mode in the partition mode table.

In this manner, the method of FIG. 10 represents an example of a method including encoding an indication that a block of video data is coded using a short distance intra-prediction (SDIP) mode, where the indication corresponds to a value of a partition mode table, and encoding the block of video data using the SDIP mode.

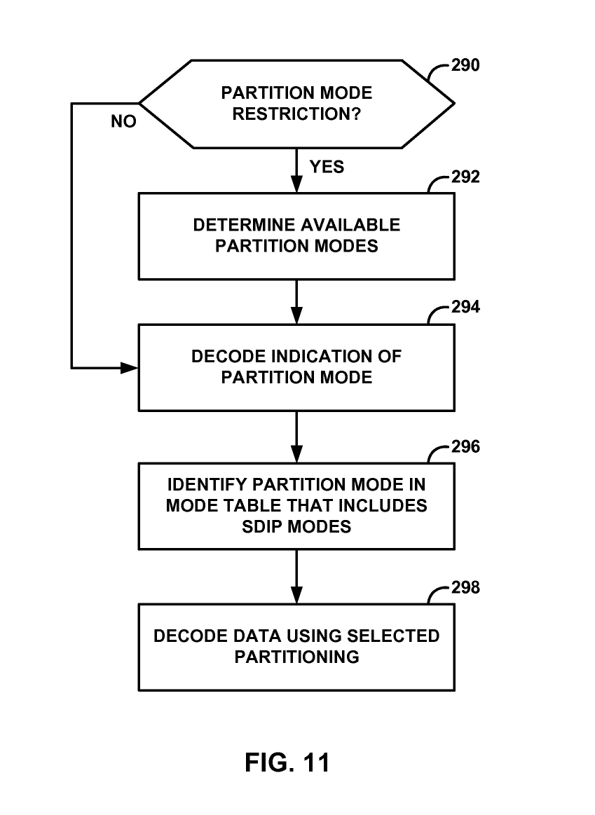

FIG. 11 is a flow diagram illustrating a technique of coding video data consistent with this disclosure. The example shown in FIG. 11 is generally described as being performed by video decoder 30 (FIGS. 1 and 3). It should be understood that, in some examples, the method of FIG. 11 may be carried out by a variety of other processors, processing units, hardware-based coding units such as encoder/decoders (CODECs), and the like.

In the example of FIG. 11, video decoder 30 initially determines whether there is a partition mode restriction when predicting video data (290). For example, as noted above, certain partition modes may be unavailable when predicting video data. That is, in some instances, SDIP modes may not be available for all CU sizes or depths. In any case, video decoder 30 may determine the partition modes that are available for partitioning a block of video data for purposes of prediction (292).

Video decoder 30 also decodes an indication of a partition mode for predicting data for a block of video data currently being decoded (294). For example, video decoder 30 may decode a bin string that maps to a partition mode in a partition mode table that includes SDIP modes. Accordingly, video decoder 30 may, based on the decoded indication, identify a partition mode for decoding the current block in a unified partition mode table that includes all of the partition modes, including SDIP modes (296).

Video decoder 30 may then decode the current block using the identified partition mode (298). For example, video decoder 30 may partition the current block using the identified partition mode. Video decoder 30 may then apply the appropriate prediction technique for each partition to generate prediction data. Video decoder 30 may add the prediction data to decoded residual data to reconstruct the current block.

In this manner, the method of FIG. 11 represents an example of a method including decoding an indication that a block of video data is coded using a short distance intra-prediction (SDIP) mode, where the indication corresponds to a value of a partition mode table, and decoding the block of video data using the SDIP mode.

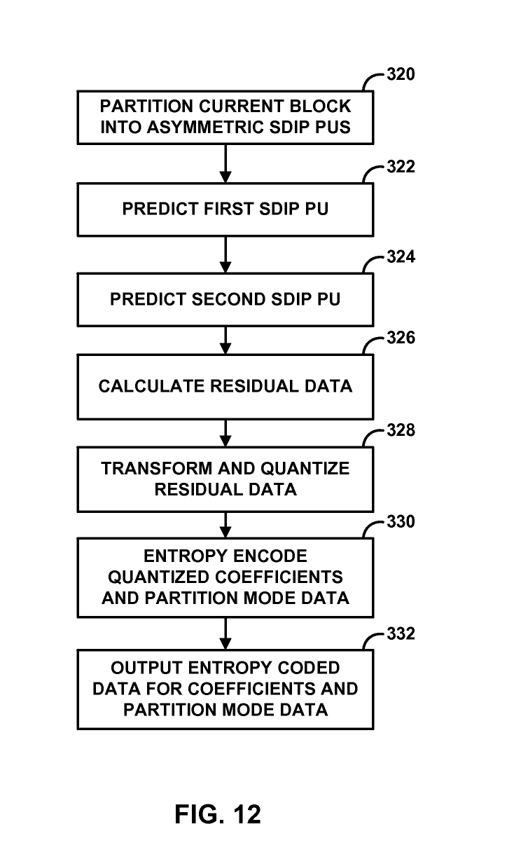

FIG. 12 is a flowchart illustrating an example method for encoding a current block. The current block may comprise a current CU or a portion of the current CU. The example shown in FIG. 12 is generally described as being performed by video encoder 20 (FIGS. 1 and 2). It should be understood that, in some examples, the method of FIG. 12 may be carried out by a variety of other processors, processing units, hardware-based coding units such as encoder/decoders (CODECs), and the like.

In this example, video encoder 20 partitions the current block into asymmetric SDIP PUs (320). Video encoder 20 may perform multiple coding passes to determine an acceptable partitioning strategy, which in this example, may correspond to asymmetric SDIP partitioning. Thus, video encoder may predict the first asymmetric SDIP PU using a first intra-prediction mode (322) and predict the second asymmetric SDIP PU using a second intra-prediction mode (324). The first and second intra-prediction modes need not necessarily be the same and may, in fact, be different modes.

Video encoder 20 may then calculate residual blocks for the current block, e.g., to produce transform units (TUs) (326). The TUs may have sizes corresponding to the respective asymmetric SDIP PUs. Alternatively, the TUs may have the same sizes as one another, which may be the same as or different from the SDIP PUs, or may have sizes represented in an RQT. To calculate the residual blocks, video encoder 20 may calculate differences between the original, uncoded block and the predicted blocks for the current block. Video encoder 20 may then transform and quantize coefficients of the residual block (328). Video encoder 20 may entropy encode the coefficients, as well as data indicating a partition mode (e.g., symmetric or asymmetric, and/or square or non-square) for the current block (330). Video encoder 20 may then output the entropy coded data of the block (332).

In this manner, the method of FIG. 12 represents an example of a method including predicting a first partition of a current block of video data using a first intra-prediction mode, wherein the first partition has a first size, predicting a second partition of the current block of video data using a second intra-prediction mode, wherein the second partition has a second size different than the first size, and coding the current block based on the predicted first and second partitions.

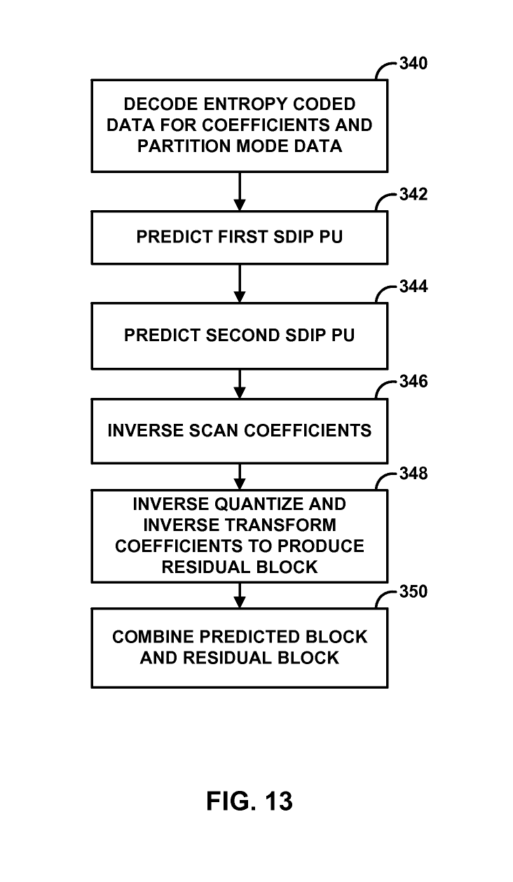

FIG. 13 is a flowchart illustrating an example method for decoding a current block of video data. The current block may comprise a current CU or a portion of the current CU. The example shown in FIG. 13 is generally described as being performed by video decoder 30 (FIGS. 1 and 3). It should be understood that, in some examples, the method of FIG. 13 may be carried out by a variety of other processors, processing units, hardware-based coding units such as encoder/decoders (CODECs), and the like.

Video decoder 30 may decode entropy coded data for quantized transform coefficients and partition mode data for a current block (340), which in this example, may indicate that the current block is asymmetric SDIP partitioned. Video decoder 30 may then predict the first SDIP PU using a first intra-prediction mode (342) and predict the second SIDP PU using a second intra-prediction mode (344). The first and second intra-prediction modes may be the same or different, and may be indicated by the entropy coded data. The entropy coded data may also indicate sizes for the PUs and spatial locations of the PUs relative to each other and/or relative to the current block.

As noted above, video decoder 30 may decode quantized transform coefficients, thereby reproducing the coefficients. Video decoder 30 may inverse scan the reproduced coefficients (346), to create a block of quantized transform coefficients. Video decoder 30 may then inverse quantize and inverse transform the coefficients to produce a residual block (348). Video decoder 30 may ultimately decode the current block by combining the predicted block and the residual block (350).

In this manner, the method of FIG. 13 represents an example of a method including predicting a first partition of a current block of video data using a first intra-prediction mode, wherein the first partition has a first size, predicting a second partition of the current block of video data using a second intra-prediction mode, wherein the second partition has a second size different than the first size, and coding the current block based on the predicted first and second partitions.

Certain aspects of this disclosure have been described with respect to the developing HEVC standard for purposes of illustration. However, the techniques described in this disclosure may be useful for other video coding processes, such as those defined according to H.264 or other standard or proprietary video coding processes not yet developed.

A video coder, as described in this disclosure, may refer to a video encoder or a video decoder. Similarly, a video coding unit may refer to a video encoder or a video decoder. Likewise, video coding may refer to video encoding or video decoding.

It is to be recognized that depending on the example, certain acts or events of any of the techniques described herein can be performed in a different sequence, may be added, merged, or left out altogether (e.g., not all described acts or events are necessary for the practice of the techniques). Moreover, in certain examples, acts or events may be performed concurrently, e.g., through multi-threaded processing, interrupt processing, or multiple processors, rather than sequentially.

In one or more examples, the functions described may be implemented in hardware, software, firmware, or any combination thereof. If implemented in software, the functions may be stored on or transmitted over, as one or more instructions or code, a computer-readable medium and executed by a hardware-based processing unit. Computer-readable media may include computer-readable storage media, which corresponds to a tangible medium such as data storage media, or communication media including any medium that facilitates transfer of a computer program from one place to another, e.g., according to a communication protocol. In this manner, computer-readable media generally may correspond to (1) tangible computer-readable storage media which is non-transitory or (2) a communication medium such as a signal or carrier wave. Data storage media may be any available media that can be accessed by one or more computers or one or more processors to retrieve instructions, code and/or data structures for implementation of the techniques described in this disclosure. A computer program product may include a computer-readable medium.

By way of example, and not limitation, such computer-readable storage media can comprise RAM, ROM, EEPROM, CD-ROM or other optical disk storage, magnetic disk storage, or other magnetic storage devices, flash memory, or any other medium that can be used to store desired program code in the form of instructions or data structures and that can be accessed by a computer. Also, any connection is properly termed a computer-readable medium. For example, if instructions are transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of medium. It should be understood, however, that computer-readable storage media and data storage media do not include connections, carrier waves, signals, or other transient media, but are instead directed to non-transient, tangible storage media. Disk and disc, as used herein, includes compact disc (CD), laser disc, optical disc, digital versatile disc (DVD), floppy disk and Blu-ray disc, where disks usually reproduce data magnetically, while discs reproduce data optically with lasers. Combinations of the above should also be included within the scope of computer-readable media.

Instructions may be executed by one or more processors, such as one or more digital signal processors (DSPs), general purpose microprocessors, application specific integrated circuits (ASICs), field programmable logic arrays (FPGAs), or other equivalent integrated or discrete logic circuitry. Accordingly, the term “processor,” as used herein may refer to any of the foregoing structure or any other structure suitable for implementation of the techniques described herein. In addition, in some aspects, the functionality described herein may be provided within dedicated hardware and/or software modules configured for encoding and decoding, or incorporated in a combined codec. Also, the techniques could be fully implemented in one or more circuits or logic elements.

The techniques of this disclosure may be implemented in a wide variety of devices or apparatuses, including a wireless handset, an integrated circuit (IC) or a set of ICs (e.g., a chip set). Various components, modules, or units are described in this disclosure to emphasize functional aspects of devices configured to perform the disclosed techniques, but do not necessarily require realization by different hardware units. Rather, as described above, various units may be combined in a codec hardware unit or provided by a collection of interoperative hardware units, including one or more processors as described above, in conjunction with suitable software and/or firmware.

Various examples have been described. These and other examples are within the scope of the following claims.

What is claimed is:

1. A method of coding video data, the method comprising:
predicting a first non-square partition of a current block of video data using a first intra-prediction mode, wherein the first non-square partition has a first size;
predicting a second non-square partition of the current block of video data using a second intra-prediction mode, wherein the second non-square partition has a second size different than the first size; and
coding the current block based on the predicted first and second non-square partitions.

2. The method of claim 1, wherein the first intra-prediction mode is different than the second intra-prediction mode.

3. The method of claim 1, wherein coding the current block comprises coding at least a first transform block corresponding to at least a portion of the first non-square partition and a second transform block corresponding to at least a portion of the second non-square partition.

4. The method of claim 3, wherein the first transform block has a first transform block size, and wherein the second transform block has a second transform block size different from the first transform block size.

5. The method of claim 4, further comprising coding a residual quadtree data structure including data representative of the first transform block size and the second transform block size.

6. The method of claim 3, wherein the first transform block has a first transform block size, and wherein the second transform block has a second transform block size equal to the first transform block size.

7. The method of claim 1, wherein the current block has a size of 2N×2N pixels.

8. The method of claim 7, wherein the first non-square partition has a size of 2N×(N/2) and wherein the second non-square partition has a size of 2N×(3N/2).

9. The method of claim 8, wherein coding the current block comprises coding at least a first transform block corresponding to at least a portion of the first non-square partition and a second transform block corresponding to at least a portion of the second non-square partition.

10. The method of claim 9, wherein the first transform block has a size equal to 2N×(N/2), and wherein the second transform block has a size equal to 2N×(3N/2).

11. The method of claim 9, wherein the first transform block has a size equal to 2N×(N/2), and wherein the second transform block has a size equal to 2N×(N/2), the method further comprising coding the current block using a third transform block having a size equal to 2N×(N/2) and a fourth transform block having a size equal to 2N×(N/2), wherein the third and fourth transform blocks correspond to remaining portions of the second non-square partition.

12. The method of claim 9, wherein the first transform block has a size equal to 2N×(N/4).

13. The method of claim 9, wherein the second transform block has a size equal to 2N×(N/4).

14. The method of claim 7, wherein the first non-square partition comprises a size of (N/2)×2N and wherein the second non-square partition comprises a size of (3N/2)×2N.

15. The method of claim 14, wherein the first transform block has a size equal to (N/2)×2N, and wherein the second transform block has a size equal to (3N/2)×2N.

16. The method of claim 14, wherein the first transform block has a size equal to (N/2)×2N, and wherein the second transform block has a size equal to (N/2)×2N, the method further comprising coding the current block using a third transform block having a size equal to (N/2)×2N and a fourth transform block having a size equal to (N/2)×2N, wherein the third and fourth transform blocks correspond to remaining portions of the second non-square partition.

17. The method of claim 7, wherein the first transform block has a size equal to (N/4)×2N.

18. The method of claim 7, wherein the second transform block has a size equal to (N/4)×2N.

19. The method of claim 1, further comprising coding an indication that the current block is coded using a short-distance intra-prediction (SDIP) mode, wherein the indication corresponds to a value of a partition mode table.

20. The method of claim 19, wherein coding the indication that the current block is coded using an SDIP mode comprises coding an indication of one of a 2N×hN SDIP mode and a hN×2N SDIP mode.

21. The method of claim 19, wherein one or more entries of the partition mode table are based at least partially on a size of the block of video data.

22. The method of claim 19, further comprising coding a second indication that a second block of video data is coded using an inter-prediction mode, wherein the second indication corresponds to a second value of the partition mode table.

23. The method of claim 19, wherein the partition mode table comprises a first partition mode table for intra-predicted video data, and further comprising coding a second indication that a second block of video data is coded using an inter-prediction mode, wherein the second indication corresponds to a value in a second, different partition mode table.

24. The method of claim 19, wherein the partition mode table comprises a first partition mode table of more than one partition mode table, and further comprising selecting one of the more than one partition mode tables based on one of a picture size, a frame rate, and a quantization parameter associated with the block of video data.

25. The method of claim 19, wherein coding the indication comprises decoding the indication, and wherein the indication comprises a bin string that maps to the SDIP mode in the partition mode table.

26. The method of claim 19, wherein coding the indication comprises encoding the indication, and wherein the indication comprises a bin string that maps to the SDIP mode in the partition mode table.

27. A apparatus for coding video data, the apparatus comprising one or more processors configured to:
predict a first non-square partition of a current block of video data using a first intra-prediction mode, wherein the first non-square partition has a first size;
predict a second non-square partition of the current block of video data using a second intra-prediction mode, wherein the second non-square partition has a second size different than the first size; and
code the current block based on the predicted first and second non-square partitions.

28. The apparatus of claim 27, wherein the first intra-prediction mode is different than the second intra-prediction mode.

29. The apparatus of claim 27, wherein to code the current block, the one or more processors are configured to code at least a first transform block corresponding to at least a portion of the first non-square partition and a second transform block corresponding to at least a portion of the second non-square partition.

30. The apparatus of claim 29, wherein the first transform block has a first transform block size, and wherein the second transform block has a second transform block size different from the first transform block size.

31. The apparatus of claim 30, further comprising coding a residual quadtree data structure including data representative of the first transform block size and the second transform block size.

32. The apparatus of claim 29, wherein the first transform block has a first transform block size, and wherein the second transform block has a second transform block size equal to the first transform block size.

33. The apparatus of claim 27, wherein the current block has a size of 2N×2N pixels.

34. The apparatus of claim 33, wherein the first non-square partition has a size of 2N×(N/2) and wherein the second non-square partition has a size of 2N×(3N/2).

35. The apparatus of claim 34, wherein to code the current block, the one or more processors are configured to code at least a first transform block corresponding to at least a portion of the first non-square partition and a second transform block corresponding to at least a portion of the second non-square partition.

36. The apparatus of claim 35, wherein the first transform block has a size equal to 2N×(N/2), and wherein the second transform block has a size equal to 2N×(3N/2).

37. The apparatus of claim 35, wherein the first transform block has a size equal to 2N×(N/2), and wherein the second transform block has a size equal to 2N×(N/2), wherein the one or more processors are further configured to code the current block using a third transform block having a size equal to 2N×(N/2) and a fourth transform block having a size equal to 2N×(N/2), wherein the third and fourth transform blocks correspond to remaining portions of the second non-square partition.

38. The apparatus of claim 37, wherein the first transform block has a size equal to 2N×(N/4).

39. The apparatus of claim 37, wherein the second transform block has a size equal to 2N×(N/4).

40. The apparatus of claim 33, wherein the first non-square partition comprises a size of (N/2)×2N and wherein the second non-square partition comprises a size of (3N/2)×2N.

41. The apparatus of claim 40, wherein the first transform block has a size equal to (N/2)×2N, and wherein the second transform block has a size equal to (3N/2)×2N.

42. The apparatus of claim 40, wherein the first transform block has a size equal to (N/2)×2N, and wherein the second transform block has a size equal to (N/2)×2N, wherein the one or more processors are further configured to code the current block using a third transform block having a size equal to (N/2)×2N and a fourth transform block having a size equal to (N/2)×2N, wherein the third and fourth transform blocks correspond to remaining portions of the second non-square partition.

43. The apparatus of claim 33, wherein the first transform block has a size equal to (N/4)×2N.

44. The apparatus of claim 33, wherein the second transform block has a size equal to (N/4)×2N.

45. The apparatus of claim 27, wherein the one or more processors are further configured to code an indication that the current block is coded using a short-distance intra-prediction (SDIP) mode, wherein the indication corresponds to a value of a partition mode table.

46. The apparatus of claim 45, wherein to code the indication that the current block is coded using an SDIP mode, the one or more processors are configured to code an indication of one of a 2N×hN SDIP mode and a hN×2N SDIP mode.

47. The apparatus of claim 45, wherein one or more entries of the partition mode table are based at least partially on a size of the block of video data.

48. The apparatus of claim 45, wherein the one or more processors are further configured to code a second indication that a second block of video data is coded using an inter-prediction mode, wherein the second indication corresponds to a second value of the partition mode table.

49. The apparatus of claim 45, wherein the partition mode table comprises a first partition mode table for intra-predicted video data, and wherein the one or more processors are further configured to code a second indication that a second block of video data is coded using an inter-prediction mode, wherein the second indication corresponds to a value in a second, different partition mode table.

50. The apparatus of claim 45, wherein the partition mode table comprises a first partition mode table of more than one partition mode table, and wherein the one or more processors are further configured to select one of the more than one partition mode tables based on one of a picture size, a frame rate, and a quantization parameter associated with the block of video data.

51. The apparatus of claim 45, wherein to code the indication, the one or more processors are configured to decode the indication, and wherein the indication comprises a bin string that maps to the SDIP mode in the partition mode table.

52. The apparatus of claim 45, wherein to code the indication, the one or more processors are configured to encode the indication, and wherein the indication comprises a bin string that maps to the SDIP mode in the partition mode table.

53. An apparatus for coding video data, the apparatus comprising:
means for predicting a first non-square partition of a current block of video data using a first intra-prediction mode, wherein the first non-square partition has a first size;
means for predicting a second non-square partition of the current block of video data using a second intra-prediction mode, wherein the second non-square partition has a second size different than the first size; and
means for coding the current block based on the predicted first and second non-square partitions.

54. The apparatus of claim 53, wherein the first intra-prediction mode is different than the second intra-prediction mode.

55. The apparatus of claim 53, wherein means for coding the current block comprises means for coding at least a first transform block corresponding to at least a portion of the first non-square partition and a second transform block corresponding to at least a portion of the second non-square partition.

56. The apparatus of claim 55, wherein the first transform block has a first transform block size, and wherein the second transform block has a second transform block size different from the first transform block size.

57. The apparatus of claim 55, wherein the first transform block has a first transform block size, and wherein the second transform block has a second transform block size equal to the first transform block size.

58. The apparatus of claim 53, further comprising means for coding an indication that the current block is coded using a short-distance intra-prediction (SDIP) mode, wherein the indication corresponds to a value of a partition mode table.

59. The apparatus of claim 58, wherein means for coding the indication that the current block is coded using an SDIP mode comprises means for coding an indication of one of a 2N×hN SDIP mode and a hN×2N SDIP mode.

60. The apparatus of claim 58, wherein one or more entries of the partition mode table are based at least partially on a size of the block of video data.

61. The apparatus of claim 58, further comprising means for coding a second indication that a second block of video data is coded using an inter-prediction mode, wherein the second indication corresponds to a second value of the partition mode table.

62. A non-transitory computer-readable storage medium having instructions stored thereon that, when executed, cause one or more processors to:
predict a first non-square partition of a current block of video data using a first intra-prediction mode, wherein the first non-square partition has a first size;
predict a second non-square partition of the current block of video data using a second intra-prediction mode, wherein the second non-square partition has a second size different than the first size; and
code the current block based on the predicted first and second non-square partitions.

63. The non-transitory computer-readable storage medium of claim 62, wherein the first intra-prediction mode is different than the second intra-prediction mode.

64. The non-transitory computer-readable storage medium of claim 62, wherein to code the current block, the instructions cause the one or more processors to code at least a first transform block corresponding to at least a portion of the first non-square partition and a second transform block corresponding to at least a portion of the second non-square partition.

65. The non-transitory computer-readable storage medium of claim 64, wherein the first transform block has a first transform block size, and wherein the second transform block has a second transform block size different from the first transform block size.

66. The non-transitory computer-readable storage medium of claim 64, wherein the first transform block has a first transform block size, and wherein the second transform block has a second transform block size equal to the first transform block size.

67. The non-transitory computer-readable storage medium of claim 62, further comprising instructions that cause the one or more processors to code an indication that the current block is coded using a short-distance intra-prediction (SDIP) mode, wherein the indication corresponds to a value of a partition mode table.

68. The non-transitory computer-readable storage medium of claim 67, wherein to code the indication that the current block is coded using an SDIP mode, the instructions cause the one or more processors to code an indication of one of a 2N×hN SDIP mode and a hN×2N SDIP mode.

69. The non-transitory computer-readable storage medium of claim 67, wherein one or more entries of the partition mode table are based at least partially on a size of the block of video data.

70. The non-transitory computer-readable storage medium of claim 67, further comprising instructions that cause the one or more processors to code a second indication that a second block of video data is coded using an inter-prediction mode, wherein the second indication corresponds to a second value of the partition mode table.
